(19) United States
(12) Patent Application Publication
(10) Pub. No.: US 2024/0392701 A1
(43) Pub. Date: Nov. 28, 2024

(54) Modular High-Performance Turbo-Compression Cooling

(71) Applicant: Colorado State University Research Foundation, Fort Collins, CO (US)

(72) Inventors: Todd Bandhauer, Fort Collins, CO (US); Nickolas Roberts, Weymouth, MA (US)

(21) Appl. No.: 18/691,113

(22) PCT Filed: Sep. 22, 2022
(86) PCT No.: PCT/US2022/044325

§ 371 Date: Mar. 12, 2024

Related U.S. Application Data
(60) Provisional application No. 63/247,451, filed on Sep. 23, 2021.

(51) Int. Cl. F01K 23/10; F01K 11/02; F01K 25/10

(52) U.S. Cl. CPC F01K 23/10; F01K 11/02; F01K 25/10

(57) ABSTRACT

An ultra-efficient turbo-compression cooling system links an organic Rankine power cycle and a vapor compression cooling cycle using a turbine and compressor that shares a single shaft and further linked to an evaporative condenser. The power cycle implements a waste heat exchanger configured to evaporate a working fluid and a turbine configured to receive the evaporated working fluid. The turbine has a plurality of vanes disposed around a central shaft and configured to rotate as the working fluid expands to a lower pressure within the turbine. An evaporative condenser then condenses the working fluid to a saturated liquid and a mechanical pump pumps the saturated liquid to reenter the waste heat waste heat exchanger. The cooling cycle implements a compressor configured to increase the pressure of the working fluid, with the evaporative condenser (shared with the power cycle) configured to condense the working fluid to a saturated liquid upon exiting the compressor, an expansion valve wherein the working fluid expands to a lower pressure, and an evaporator rejecting heat from a circulating fluid to the working fluid, thereby cooling the circulating fluid.

### CROSS REFERENCE TO RELATED APPLICATION

The present application claims priority to U.S. Provisional Patent Application 63/247,451, filed on Sep. 23, 2021, which is hereby incorporated by reference.

### STATEMENT REGARDING FEDERALLY SPONSORED RESEARCH OR DEVELOPMENT

This invention is made with government support under grant DE-EE0008325 awarded by the Department of Energy. The government has certain rights in the invention.

### BACKGROUND OF THE INVENTION

The present invention relates to turbo-compression cooling, and specifically, a system implementing a turbine coupled to a compressor to utilize low-grade waste heat to power a cooling cycle in various applications.

Power production with fossil fuels is inherently inefficient. Approximately 30% of the trapped energy in the fuel is converted to useful power (mechanical or electrical), while the remaining fuel energy is typically rejected as waste heat. As the race against climate change intensifies, new ways to improve the efficiency of fuel-driven prime movers is desired.

Industries of all types produce waste heat because of inefficient system performance. Conventionally, the waste heat is exhausted into the environment in the form of steam, heated water or air, or hot exhaust gases. As an example, an industrial plant operating a steam generator produces waste heat that is exhausted into the environment through its exhaust stack. As another example, marine diesel engines include various thermal energy streams (e.g., engine jacket water, lubrication oil, and aftercooler air) that reject heat to seawater. There is a significant amount of electricity usage that is dedicated to cooling: 20% of electricity consumption in the U.S. manufacturing sector is used in facility HVAC/process cooling, 40% of end-use energy in residential Europe is attributed to heating and cooling, and air conditioning represents 40-60% of the energy consumption of buildings in China. Therefore, these systems, among others, can increase overall efficiency by recovering waste heat.

Conventional systems for waste heat recovery can be large, cumbersome, and expensive. Additionally, each industry includes its own unique challenges to utilizing waste heat to improve system performance. It is with these challenges in mind, among others, that aspects of the ultra-efficient turbo-compression cooling systems are developed.

### SUMMARY OF THE INVENTION

There is a significant global opportunity to capture and utilize low grade waste heat to reduce fossil fuel consumption, greenhouse gas emissions, and improve energy efficiency across a wide range of industries. Although solar and wind energy could decarbonize electrically driven heating, ventilation, and air conditioning (HVAC) systems, there are challenges with large-scale renewable energy generation, including intermittent generation, mismatches between supply and demand, and high cost of energy storage. Until these challenges are addressed, it will be critical to boost the efficiency of currently in use prime movers with transitional technologies.

The efficiency of high-speed centrifugal turbomachinery has been continually improving in the last 200 years as Rankine cycles, Brayton cycles, and vapor compression cycles have been the subject of widespread research work and used heavily in commercial and industrial settings. Organic Rankine-vapor compression (ORVC) technology is promising due to its potential operational flexibility, it is a well-understood technology, and can use lower-cost materials. The organic refrigerant working fluids in the ORVC system are not corrosive and operate at moderate pressures, so low-cost steel or aluminum materials can be used for piping, fittings, valves, and heat exchangers.

One embodiment of the present invention provides a 300 kWth ORVC system operating at standard rating conditions (and enables a direct comparison to single effect absorption chillers to evaluate the technical potential of ORVC systems). R1234ze(E), a next-generation low global warming potential (GWP) refrigerant, is the working fluid in the power and cooling cycles. It is anticipated that R1234ze(E) will be used in the future of organic Rankine and refrigeration cycles as hydrofluorocarbon-based refrigerants are phased out.

The present invention includes three different heat recuperation schemes (recuperator, suction line heat exchanger (SLHX), and cross cycle economizer). Thus, the present invention provides experimental validation of heat recovery concepts. The additional heat recovery from the SLHX and cross cycle economizer improve ORVC performance which enhances the overall coefficient of performance (COP) of the system. Testing procedures are carried out at temperatures and conditions that are identical to rating standards for vapor compression systems to provide a direct comparison to commercially available technologies.

An alternative embodiment of the present invention provides an ORVC system that links an organic Rankine power cycle and a vapor compression cooling cycle using a turbine and compressor sharing a single shaft. Thus, the ultra-efficient turbo-compression cooling system includes a power cycle and a cooling cycle coupled to the other. The power cycle implements a waste heat exchanger configured to evaporate a first working fluid and a turbine configured to receive the evaporated working fluid. The turbine has a plurality of vanes disposed around a central shaft and configured to rotate as the first working fluid expands to a lower pressure within the turbine. A condenser then condenses the first working fluid to a saturated liquid and a mechanical pump pumps the saturated liquid to reenter the waste heat exchanger. The cooling cycle implements a compressor configured to increase the pressure of a second working fluid, a condenser configured to condense the second working fluid to a saturated liquid upon exiting the compressor, an expansion valve wherein the second working fluid expands to a lower pressure, and an evaporator rejecting heat from a circulating fluid to the second working fluid, thereby cooling the circulating fluid. The turbine and compressor can be coupled to the other, thereby coupling the power cycle and the cooling cycle.

In some instances, the first working fluid and the second working fluid can be the same fluid. In other instances, the first working fluid is a thermal fluid and the second working fluid is a cooling fluid. The thermal fluid is optimized for use in a power cycle and the cooling fluid is optimized for use in a cooling cycle. The first and second working fluids can be refrigerants, hydrocarbons, inorganic fluids, and/or any combination thereof. The first and second working fluids can be R1234ze(E).

An alternative embodiment of the present invention provides a method of turbo-compression cooling includes receiving, from a power generation system, heat waste in a waste heat waste heat exchanger and evaporating a first working fluid using the heat waste in the waste heat waste heat exchanger, thereby generating mechanical power through expansion of the first working fluid to a lower pressure in a turbine. The expansion of the first working fluid within the turbine rotates the one or more turbine vanes and condenses the first working fluid to a saturated liquid in a condenser. The saturated liquid is pressurized through a mechanical pump to re-enter the waste heat exchanger. The generated mechanical power is transferred to a compressor. The compressor is configured to receive a second working fluid and compress the second working fluid to increase the pressure. The second working fluid is then condensed in a condenser to a saturated liquid and expanded to a lower pressure in an expansion valve. A circulating cooling fluid rejects heat through an evaporator to the second working fluid. In some instances, the evaporator can be a liquid coupled evaporator configured to reject heat to a liquid. In other instances, the evaporator can reject heat to air or another phase change fluid. The system can also include a recuperator configured to reject heat from the first working fluid exiting the turbine, and absorbing heat in the first working fluid exiting the mechanical pump.

An alternative embodiment of the present invention provides an ultra-efficient turbo-compression cooling system that links an organic Rankine power cycle and a vapor compression cooling cycle using a turbine and compressor that shares a single shaft and is further linked to an evaporative condenser. In this respect, the power cycle implements a waste heat exchanger configured to evaporate a working fluid and a turbine configured to receive the evaporated working fluid. The turbine has a plurality of vanes disposed around a central shaft and configured to rotate as the working fluid expands to a lower pressure within the turbine. An evaporative condenser then condenses the working fluid to a saturated liquid and a mechanical pump pumps the saturated liquid to reenter the waste heat waste heat exchanger. The cooling cycle implements a compressor configured to increase the pressure of the working fluid, with the evaporative condenser (shared with the power cycle) configured to condense the working fluid to a saturated liquid upon exiting the compressor, an expansion valve wherein the working fluid expands to a lower pressure, and an evaporator rejecting heat from a circulating fluid to the working fluid, thereby cooling the circulating fluid. The turbine and compressor can be coupled to the other, thereby coupling the power cycle and the cooling cycle.

The evaporative condenser receives the working fluid, which in some embodiments, is circulated through a condensing coil, which is continually wetted on the outside by a recirculating water system. Flow air is pulled over the coil by fans, thus causing a small portion of the recirculating water to evaporate. The evaporation removes heat from the vapor in the coil, causing the working fluid to condense.

The present invention provides an evaporative condenser using a single heat rejection process which involves the evaporation of heated water from the external surface of the condensing coil. In contrast, for chiller systems that utilize a cooling tower, heat transfer from the cooling process involves two stages. The heat generated by an industrial or commercial process is first transferred to the circulating chilled working fluid by the condenser before a second step of atmospheric heat rejection at the cooling tower.

It is thus a feature of at least one embodiment of the present invention to provide a cooling system that directly rejects heat to the ambient to lower the saturation temperature of the refrigerant and improve power and cooling cycle performance.

It is thus a feature of at least one embodiment of the present invention to remove heat rejection equipment by eliminating water-cooled condensers, water circulation pumps, and piping to off-site cooling tower.

It is thus a feature of at least one embodiment of the present invention to reduce cost and volume of the system by using a medium pressure refrigerant and more compact heat exchanger technology.

Specifically, the present invention provides a system for turbo-compression cooling in a facility having a cooling loop and a generator having a plurality of waste heat streams, the system comprising a power cycle comprising a first working fluid; a waste heat boiler configured to evaporate the working fluid, the waste heat boiler configured to receive waste heat from one or more of the plurality of waste heat streams from the generator; a turbine configured to receive the evaporated first working fluid from the waste heat boiler, the turbine having a plurality of vanes disposed around a central shaft and configured to rotate about the central shaft, the plurality of vanes configured to rotate as the first working fluid expands to a lower pressure; and a first evaporative condenser configured to receive the first working fluid from the turbine and configured to condense the first working fluid to a saturated or subcooled liquid; a cooling cycle comprising: a second working fluid; a first compressor configured to increase the pressure of the second working fluid; a second evaporative condenser configured to receive the second working fluid from the first compressor and configured to condense the second working fluid to a saturated or subcooled liquid; an expansion valve configured to receive the second working fluid from said evaporative condenser and configured to expand the second working fluid to a lower pressure; an evaporator configured to receive the second working fluid from the expansion valve and configured to reject heat from a circulating fluid to the second working fluid, thereby cooling the circulating fluid; and wherein the turbine and first compressor are coupled to the other, thereby coupling the power cycle and the cooling cycle.

The first evaporative condenser and second evaporative condenser can be a common unit.

The evaporative condenser comprises a coil receiving the first and second working fluid and a recirculating water system configured to deposit spray water on an exterior of the coil.

The evaporative condenser further comprises a fan configured to pull air over the coil.

The first and second working fluid is a single refrigerant.

The single refrigerant is R1234ze(E).

The recuperator is configured to receive heat rejected by the first working fluid, and wherein the recuperator is configured to transfer the rejected heat to the saturated or subcooled liquid as the first working fluid re-enters the waste heat boiler.

A cross-cycle economizer is configured to receive and cool the second working fluid exiting the first compressor and heat the first fluid exiting the pump.

A suction-line heat exchanger is configured to receive and heat the second working fluid prior to compressing the second working fluid via the first compressor.

A second compressor is configured to discharge the second working fluid to the first compressor wherein the second compressor is electrically powered and wherein the first compressor is powered via the waste heat from the waste heat boiler.

A third compressor is configured to discharge the second working fluid from the third compressor to the second compressor wherein the third compressor is electrically powered.

A cooling-cycle economizer is configured to receive and cool a first portion of the second working fluid prior to entering the section-line heat exchanger and to receive a second portion of the second working fluid expanded by a second expansion valve and exiting the second evaporative condenser prior to entering the cooling-cycle economizer.

An intercooler is configured to receive and cool the second working fluid from the second compressor prior to compressing the second working fluid via the first compressor.

A fourth compressor is configured to discharge the second working fluid to the first compressor wherein the fourth compressor is powered via the waste heat from the waste heat.

The circulating fluid is at least one of water, water glycol mixture, ammonia, and air and is part of the cooling loop.

A method of turbo-compression cooling, the method comprising: receiving, from a waste heat source, heat waste in a waste heat boiler; evaporating a first working fluid using the heat waste in the waste heat boiler; generating mechanical power through expansion of the first working fluid to a lower pressure in a turbine, the expansion of the first working fluid rotating one or more turbine vanes; condensing the first working fluid to a saturated or subcooled liquid in an evaporative condenser; pressurizing the saturated or subcooled liquid through a mechanical pump to re-enter the waste heat boiler; transferring the generated mechanical power to a first compressor, the first compressor configured to receive a second working fluid; compressing the second working fluid via the first compressor thereby increasing the pressure of the saturated vapor; condensing the second working fluid in said evaporative condenser to a saturated or subcooled liquid; expanding the second working fluid to a lower pressure via an expansion valve; and rejecting heat through an evaporator from circulating cooling fluid to the second working fluid.

### BRIEF DESCRIPTION OF THE DRAWINGS

FIG. 1 is a simplified schematic diagram of an organic Rankine-vapor compression (ORVC) thermally activated chiller of the present invention;

FIG. 2 is a schematic diagram of the system cycle for the ORVC system of FIG. 1 and used for baseline thermodynamic modeling;

FIG. 3 are T-s and P-h diagrams for the baseline simulations for the ORVC system of FIGS. 1 and 2 with R1234ze(E) working fluid with the external stream temperatures (boiler glycol, condenser glycol, and chilled water) overlayed on the T-s diagram;

FIG. 4 is a schematic diagram of one embodiment of the ORVC thermally activated chiller of the present invention;

FIG. 5 is a power cycle T-s diagram from the experimental testing for the ORVC system of FIG. 4;

FIG. 6 is a graph showing a performance comparison of the power cycle experimental data (dashed line) for the ORVC system of FIG. 4 and baseline modeling prediction (solid line);

FIG. 7 is a graph showing a performance comparison of the cooling cycle experimental data (dashed line) for the ORVC system of FIG. 4 and baseline modeling prediction (solid line);

FIG. 8 is a chart showing a sensitivity analysis of experimental performance constraints on the baseline model;

FIG. 9 is a schematic diagram of an alternative embodiment of an ORVC thermally activated chiller of the present invention which has a modular configuration and includes an evaporative condenser;

FIG. 10 is a schematic diagram of an alternative embodiment of the ORVC thermally activated chiller of FIG. 9 which has a modular configuration and further, and optionally, includes a heat recuperator;

FIG. 11 is a schematic diagram of an alternative embodiment of the ORVC thermally activated chiller of FIG. 10 which has a modular configuration and further, and optionally, includes a suction line;

FIG. 12 is a schematic diagram of an alternative embodiment of the ORVC thermally activated chiller of FIG. 11 which has a modular configuration and further, and optionally, includes a cross-cycle economizer;

FIG. 13 is a schematic diagram of an alternative embodiment of the ORVC thermally activated chiller of FIG. 12 which has a modular configuration and further, and optionally, includes an electric compressor;

FIG. 14 is a schematic diagram of an alternative embodiment of the ORVC thermally activated chiller of FIG. 13 which has a modular configuration and further, and optionally, includes a power cycle intercooler; and

FIG. 15 is a schematic diagram of an alternative embodiment of the ORVC thermally activated chiller of FIG. 14 which has a modular configuration and further, and optionally, includes a cooling cycle economizer.

### DETAILED DESCRIPTION OF THE PREFERRED EMBODIMENTS

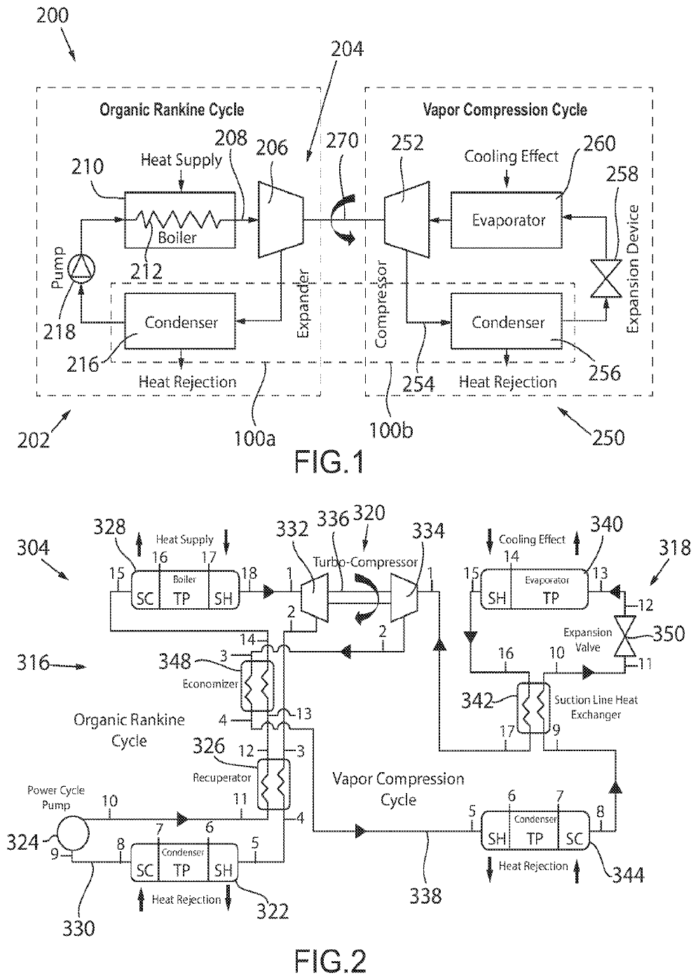

Referring to FIG. 1, an ultra-efficient turbo-compressor cooling system 200 of the present invention is an organic Rankine vapor compression cycle (ORVC) where a standard vapor compression cycle 250 (cooling cycle) is driven by the energy produced from an organic Rankine cycle 202 (ORC or power cycle). The ultra-efficient turbo-compressor cooling system 200 can have a power cycle 202 and a cooling cycle 250 coupled together by a turbo-compressor 204. The ultra-efficient turbo-compressor cooling system 200 can be implemented within various applications and industries, such as an ammonia-cooling loop in a refrigeration system of a food or beverage industrial plant.

Generally, the power cycle 202 operates with a first working fluid 208 receiving waste heat from a waste heat source, such as from the industrial plant or the heat dissipated in a cooling tower of another cooling system. The waste heat, instead of being dissipated in the cooling tower, may be used to heat the first working fluid 208 in the power cycle 202. Additionally, or alternatively, the waste heat may be from the exhaust stack of a boiler, engine coolant from an engine, and/or unused fuel (e.g., biogas) within the industrial plant.

As shown in FIG. 1, the waste heat boiler 210 can have a heat exchanger 212 configured to reject waste heat from the cooling system 200 to the first working fluid 208. Thus, the waste heat boiler 210 can receive a fluid from the cooling system 200 at a first temperature and exit the waste heat boiler 210 at a second temperature, lower than the first temperature. Thus, the heat exchanger 212 utilizes the waste heat from the cooling system 200 to evaporate the first working fluid 208 in the waste heat boiler 210. The first working fluid 208 exits the waste heat boiler 210 as a vapor and then enters the turbine 206.

The turbine 206 can have a plurality of vanes coupled to a shaft 270, the plurality of vanes configured to impart rotation upon the shaft 270 as the first working fluid 208 expands within the turbine 206. Expansion of the first working fluid 208 within the turbine 206 generates mechanical power, thus rotating the shaft 270. In some instances, the turbine 206 can be a multi-stage turbine having a plurality of vanes arranged to allow expansion of the first working fluid 208 and a second plurality of vanes arranged to allow further expansion of the first working fluid 208. The plurality of vanes and the plurality of second vanes are arranged for optimal performance based on the operating pressures, temperatures, and first working fluid 208 of the power cycle 202 of the ultra-efficient turbo-compressor cooling system 200.

Upon exiting the turbine 206, the first working fluid 208 enters a condenser 216 (or shared evaporative condenser 100 or separate evaporative condenser 100a as further described below). In certain instances, the condenser 216 may be a dry air condenser, or a wet air condenser. The condenser 216 condenses the first working fluid 208 from a vapor to a saturated liquid. The condenser 216 can be an air-cooled heat exchanger allowing the first working fluid 208 to reject heat to the environment. The first working fluid 208 leaves the condenser 216 as a saturated liquid and enters a mechanical pump 218. The mechanical pump 218 re-pressurizes the first working fluid 208 and circulates the working fluid 208 back to the waste heat boiler 210.

While the ultra-efficient turbo-compressor cooling system 200 is shown and described with respect to the power cycle 202 as shown in FIG. 1, the power cycle 202 may alternatively include a recuperator as described with respect to FIG. 2. The recuperator may be omitted for power cycles involving working fluids with specific properties that mitigate the efficiency gain provided by the recuperator.

Still referring to FIG. 1, the cooling cycle 250 operates with a second working fluid 254. The cooling cycle 250 operates by a compressor 252 receiving the mechanical work generated by the turbine 206 as described above. The second working fluid 254 enters the compressor as a saturated vapor, and the compressor 252 raises the pressure of the second working fluid 254.

In some instances, the compressor 252 can be a multi-stage compressor having a plurality of impellers arranged to allow compression of the second working fluid 254 and a second plurality of impellers arranged to allow further expansion of the second working fluid 254. The plurality of impellers and the plurality of second impellers are arranged for optimal performance based on the operating pressures, temperatures, and second working fluid 208 of the cooling cycle 250 of the ultra-efficient turbo-compressor cooling system 200.

The second working fluid 254 then moves from the compressor 252 to a condenser 256 (or shared evaporative condenser 100 or separate evaporative condenser 100b as further described below). The condenser 256 is an air-cooled heat exchanger condensing the second working fluid 254 from a slightly superheated vapor to a saturated or subcooled liquid. The condenser 256 can have a forced airflow across the heat exchanger to increase efficiency and cooling of the second working fluid. The second working fluid 254 exits the condenser 256 and enters an expansion valve 258.

The expansion valve 258 can operate as a flow control device within the cooling cycle 250. The expansion valve 258 controls the amount of the second working fluid 254 flowing from the condenser 256 to an evaporator 260. The high-pressure liquid second working fluid 254 exiting the condenser 256 enters the expansion valve 258, which allows a portion of the second working fluid 254 to enter the evaporator 260. The expansion valve 258 allows a pressure drop in the second working fluid 254, thus expanding to a lower pressure prior to entering the evaporator 260.

The expansion valve 258 can have a temperature-sensing bulb filled with a gas similar to the second working fluid 254. The expansion valve 258 opens as the temperature on the bulb increases from the second working fluid 254 exiting the condenser 256. The change in temperature creates a change in pressure on a diaphragm and opens the expansion valve 258. The diaphragm can be biased to a closed position by a biasing element, such as a spring or actuator, and the change in pressure on the diaphragm and causes the biasing element to move the expansion valve 258 to an open position.

The evaporator 260 receives the second working fluid 254 from the expansion valve 258 and allows expansion to a phase that includes both liquid and vapor, with more liquid that vapor. The evaporator 260 passes the second working fluid 254 through to absorb heat from a cooling fluid, such as the fluid from the cooling system 200, thereby generating the desired cooling effect by reducing the temperature of the cooling fluid. The expansion valve 258 is used to limit flow of the second working fluid 254 into the evaporator 260 to keep pressure low and allow expansion of the second working fluid 254 into a combined liquid and vapor state, with more liquid that vapor.

The evaporator 260 can receive a cooling fluid, from the cooling system 200, at a first predetermined temperature and discharge the cooling fluid at a second predetermined temperature. The second predetermined temperature being lower than the first predetermined temperature. The temperature change occurs because of the second working fluid 254 absorbing heat from the circulating cooling fluid.

The first working fluid 208 and the second working fluid 254 can be hermetically sealed within the turbo-compressor 204 and may be the same fluid.

The first working fluid can be a thermal fluid optimized for use in the power cycle 202. Representative thermal fluids can include refrigerants, hydrocarbons, inorganic fluids, and/or any combination thereof, which can be operate in the subcritical two-phase region or the supercritical region depending on the waste heat temperature and fluid flow rate and the desired trade-off between compactness and COP. In one embodiment, as described below, the subcritical fluid is R1234ze(E) but may also be CO2, R404A, R407C, R134a, hydrocarbons, hydrofluorocarbon, hydrofluoroethers, and hydrofluoroolefins, among others.

The second working fluid 254 can be a cooling fluid optimized for use in the cooling cycle 250. Representative cooling fluids can include refrigerants, hydrocarbons, inorganic fluids, and/or any combination thereof, which can be operate in the subcritical two-phase region or the supercritical region depending on the waste heat temperature and fluid flow rate and the desired trade-off between compactness and COP. In one embodiment, as described below, the subcritical fluid is R1234ze(E) but may also be CO2, R404A, R407C, R134a, hydrocarbons, hydrofluorocarbon, hydrofluoroethers, and hydrofluoroolefins, among others.

For a further description of the turbo compression cooling systems and methods, among other subject matter, reference is made to U.S. Pat. No. 10,294,826 and U.S. Patent Application Publication 2021/0156597, both assigned to the present applicant, and each of which is hereby incorporated by reference.

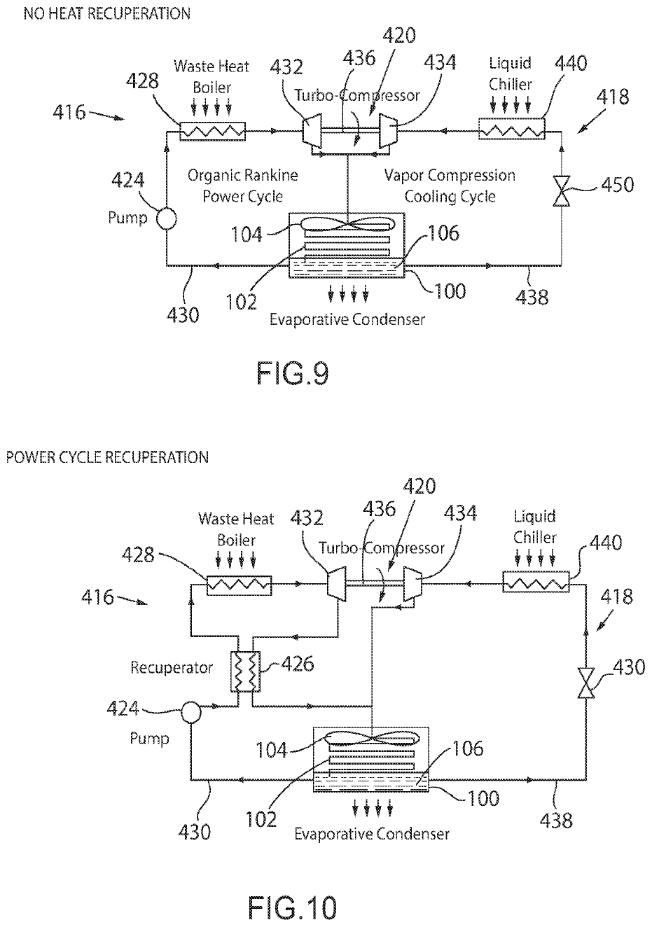

In certain embodiments described below, and with respect to FIGS. 9 through 15, the first working fluid 208 and the second working fluid 254 are the same refrigerant and are received by evaporative condensers 100a, 100b rather than condensers 216 and 256 of the power cycle 202 and cooling cycle 250, respectively, as shown in FIGS. 1 through 2. The evaporative condensers 100a, 100b pass the first working fluid 208 and the second working fluid 254, respectively, through a closed circuit coolant tubing or condensing coil 102 to absorb heat from a recirculating water system 106 spraying water on the exterior of the condensing coil 102, thereby generating the desired cooling effect by reducing the temperature of the first working fluid 208 and the second working fluid 254 and causing the vapor within the condensing coil 102 to condense. Thus, the evaporative condensers 100a, 100b condenses the first working fluid 208 and the second working fluid 254, respectively, from a vapor to a saturated liquid.

Specifically, the recirculating water system 106 may work to transfer heat away from the first working fluid 208 and the second working fluid 254 by spraying water on the outside of the condenser coil 102 and a fan 104 pulling flow air over the condenser coil 102 (e.g., by forced draft or induced draft) causing a small portion of the spraying water to evaporate and thus condensing the first working fluid 208 and the second working fluid 254.

The first working fluid (or refrigerant) 208 leaves the evaporative condenser 100a as a saturated liquid and enters the mechanical pump 218 as previously discussed above to complete the power cycle 202. The second working fluid (or refrigerant) 254 exits the evaporative condenser 100b as a saturated liquid and enters the expansion valve 258 as previously discussed above to complete the cooling cycle 250.

It is understood that in certain embodiments, the evaporative condenser 100a and the evaporative condenser 100b may be a shared single unit evaporative condenser 100 instead of separate units 100a and 100b.

The invention will be further described in the following examples, which do not limit the scope of the invention described in the claims.

### EXAMPLES

### Example 1: ORVC Chiller Using Low GWP Refrigerant R1234ze(E)

Referring to FIG. 2, a process flow diagram of an ORVC chiller 304 of the present invention is shown. The ORVC chiller 304 design incorporates recuperative heat exchangers to enhance the thermodynamic performance and to expand the operational envelope of the system. The ORVC chiller 304 consists of two integrated thermodynamic cycles, a power cycle 316 and a cooling cycle 318, that are linked by a high efficiency turbo-compressor 320 and compact heat exchanger technology.

In the power cycle 316, high pressure power cycle fluid 330, e.g., R1234ze(E), leaving the condenser 322 is pressurized by a low power pump 324 and subsequently vaporized and superheated in a two-fluid recuperator 326, an economizer 348, and then in the boiling heat exchanger or waste heat boiler 328 by absorbing thermal energy from the high temperature glycol stream. In one embodiment, the waste heat boiler 328 is supplied heat via the jacket water and lubricating oil that is used to cool the diesel generators. In particular, the jacket water and lubricating oil provide heat to the fluid in the power cycle 316 after it has been heated by the diesel generators. By rejecting the heat from the jacket water and lubricating oil to the fluid in the power cycle 316, the jacket water and lubricating oil is thereby cooled, and converting this heat to cooling increases the efficiency of the overall system, generally.

Then, the high pressure, vaporized power cycle fluid 330 is expanded to a low pressure in the radial turbine 332 to produce mechanical power, which directly powers the centrifugal compressor 334 on the vapor compression cooling cycle 318. The power cycle fluid 330 leaving the turbine 332 exchanges heat with the power cycle fluid 330 exiting the power cycle pump 324 in a recuperative heat exchanger or recuperator 326. In particular, the subcooled power cycle fluid 330 is heated by the discharge line from the turbine 332 to the recuperator 326. Preheating the power cycle fluid 330 in the recuperator prior to entering the boiler 328 decreases the amount of external heat required to vaporize the power cycle fluid 330 and bring it to the desired temperature.

After recuperation, the power cycle fluid 330 is fully liquefied and subcooled in the liquid-coupled condenser 322 and pressurized through the power cycle pump 324. The liquid heat rejection stream is glycol, which ultimately rejects the heat to the ambient in a hybrid, evaporative cooling tower. The pressurized power cycle fluid 330 is pre-heated in the recuperator 326 and the economizer 348 heat exchangers before entering the boiler 328 to be vaporized once again to complete the cycle.

More particularly, the economizer 348 has a first passage for the cooling cycle fluid 338 that enters directly after discharge from the compressor 334, and a second passage for the power cycle fluid 330 to pass through. The cooling cycle fluid 338 is hotter than the power cycle fluid 330 at this stage of the cycle and thus heat is transferred to the power cycle fluid 330 to pre-heat the power cycle fluid 330 prior to entering the waste heat boiler 328.

The recuperator 326 and economizer 348 are both heat exchangers that pre-heat the fluid 330 and improve the efficiency of the power cycle 316 and captures some of the excess heat in both the power cycle 316 and cooling cycle 318, respectively.

In the vapor compression cooling cycle 318, the cooling cycle fluid 338 is pressurized by the compressor 334. The compressor discharge, at a high temperature and pressure, enters the economizer 348 and preheats the power cycle fluid 330 prior to entering the boiler 328. The heat recuperation in the economizer 348 increases the power output of the turbine 332 without requiring additional external heat input, improving the efficiency of the organic Rankine cycle. After the economizer 348, the cooling cycle fluid 338 is fully liquefied and subcooled in the condenser 322 by rejecting heat to a stream of liquid glycol.

The compressor discharge has additional energy due to the incorporation of a suction line heat exchanger (SLHX) 342. The liquefied cooling cycle fluid 338 enters the SLHX 342 (where heat is transferred to the cooling cycle fluid 338 entering the compressor 334), which further pre-cools the liquefied cooling cycle fluid 338 after exiting the condenser 344 but before entering the expansion valve 350. The liquefied cooling cycle fluid 338 is throttled in the expansion valve 350 to decrease the refrigerant pressure and thus, the temperature.

After the throttling process, the two-phase cooling cycle fluid 338 enters the evaporator 340 to absorb heat from a water stream to provide the desired cooling effect. The evaporator 340 may be used in a cooling process within the facility such as, for example, chilling water or another substance, and thus reduces the inlet enthalpy in the evaporator 340 and substantially improves the performance of the cooling cycle 318.

The fully vaporized cooling cycle fluid 338 at the evaporator 340 outlet is superheated in the SLHX 342 by the higher temperature refrigerant at the condenser 344 outlet. The SLHX 342 provides additional superheat at the compressor 334 inlet to ensure no liquid droplets entered the rotating machinery, which could severely damage the device. Following the additional superheat in the SLHX 342, the refrigerant is pressurized in the compressor 334 to complete the cycle.

In a typical vapor compression cooling system, the SLHX 342 provides small improvements to thermal performance because the higher compressor inlet temperature will increase the condenser heat duty. However, in this system, the extra heat is captured in the power cycle 316, thereby increasing the overall system performance.

The turbine 332 and compressor 334 are directly coupled on a single shaft 336, so the same fluid or refrigerant is used in the organic Rankine cycle (ORC) and the vapor compression cycle (VCC). In one embodiment, the same working fluid 330, 338 is a hydrofluoroolefin (HFO), for example, R1234ze(E). The R1234ze(E) is used because it has favorable thermodynamic characteristics, low GWP, and the fluid is not flammable or toxic. The saturation pressures of R1234ze(E) at the high, medium, and low temperature reservoirs enables use of inexpensive piping, fittings, and valves. In addition, R1234ze(E) has a GWP<1, which makes it a good candidate for future refrigeration systems.

The direct coupling of the turbine 332 and compressor 334 has a higher power transfer efficiency than other solutions, such as gearboxes and magnetic couplings. When there is sufficient waste heat, there are no challenges with turbocompressor controls. The turbine 332 generates sufficient power for the compressor 334 to overcome stall, since the pressure ratio of the turbo-compressor 320 is set by the medium and low temperature reservoirs. Insufficient power delivery from the turbine 332 results in compressor 334 stall or surge, which reduces the refrigerant mass flow rate and thus, the cooling capacity.

### Materials and Methods

The ORVC chiller 304 is designed to provide 300 kWth of chilled water to support comfort cooling demands at U.S. industrial facilities using waste heat from engine coolant (˜91° C.) from a stationary reciprocating generator. Chilled water temperatures (12° C. at the inlet and 7° C. at the outlet) and condenser water temperatures (30° C. to 35° C.) are selected to match industry standard requirements for commercial and industrial chillers. Pure water is used for the chilled media stream.

In the condensers, a 50% mixture of ethylene glycol and water by volume is used. A 50% mixture of ethylene glycol and water is used in the waste heat stream to mimic coolants used for stationary generators. The waste heat thermal supply temperature is 91° C. to represent standard temperatures of engine coolant and the heat source temperatures for commercially available Lithium Bromide-water absorption chillers. The turbine isentropic efficiency is 83.1% and the compressor is 82.0%. The power transfer efficiency from the turbine to the compressor is 94.3%.

The phase change pinch point temperature in the boiler is 2.3° C., while the phase change pinch points in the evaporator and condensers are set to 0.4° C. and 1.2° C./1.1° C., respectively. The phase change pinch point temperature difference is between the refrigerant saturation temperature and the exit temperature of the external fluid from the two-phase heat transfer region (power cycle points 6 and 16 and cooling cycle points 6 and 13 from FIG. 2). Minimizing the pinch temperature in each heat exchanger can increase the power output of the turbine and decrease the power requirements of the compressor, yielding improved performance at the cost of larger heat exchangers. The tradeoff between size and performance is considered during the sizing and selection of each heat exchanger to prevent prohibitively large sizes. Realistic heat exchanger performance targets are generated. The effectiveness in the superheated vapor region of the boiler outlet is 98.5% to prevent liquid from entering the turbine. Superheat at the evaporator outlet is 0.6° C. to prevent liquid droplets forming during compression. The subcooling on the condensers is 1.0° C.

Using the design considerations and performance assumptions, a thermodynamic model is solved in Engineering Equation Solver to simulate the performance of the ORVC chiller 304. The inputs to the simulation are shown in Table 1. The analysis assumed the system is operating at steady state with well-insulated piping to prevent any heat losses. The expansion valve on the vapor compression cycle is isenthalpic. Pressure loss between each component is set to 5.48 kPa, based on loss estimates and length of pipe runs. Potential gravitational effects on system pressure are ignored.

TABLE 1
Baseline thermodynamic model inputs.

| Model Input | Value | Model Input | Value | | Model Input | Value |
|---|---|---|---|---|---|---|
| η_{s, turbine} | 83.1% | Waste Heat Boiler | | | Cross Cycle Economizer | |
| η_{s, compressor} | 82.0% | Superheated ε | 98.5% | | ε | 84.5% |
| η_{shaft} | 94.3% | Phase Change | 2.3° | C. | Vapor | 5.6 kPa |
| | | Pinch Temperature | | | ΔP | |
| η_{s, pump} | 30.0% | Refrigerant | 11 | kPa | Liquid | 6.6 kPa |
| | | ΔP | | | ΔP | |
| T_{boiler, in/out} | 91° C./86° C. | Power Cycle Condenser | | | Recuperator | |
| T_{condenser, in/out} | 30° C./35° C. | Degree of Subcooling | 1.0° | C. | ε | 84.4% |
| T_{chiller, in/out} | 12° C./7° C. | Phase Change | 1.2° | C. | Vapor | 5.0 kPa |

| Pinch Temperature | | | ΔP | |
|---|---|---|---|---|
| Refrigerant | 5.0 | kPa | Liquid | 4.6 kPa |
| ΔP | | | ΔP | |
| Cooling Cycle Condenser | | | Suction Line Heat Exchanger | |
| Degree of Subcooling | 1.0° | C. | ε | 88.4% |
| Phase Change | 1.1° | C. | Vapor | 4.5 kPa |
| Pinch Temperature | | | ΔP | |
| Refrigerant | 5.0 | kPa | Liquid | 3.5 kPa |
| ΔP | | | ΔP | |
| Cooling Cycle Evaporator | | | | |
| Degree of Superheat | 0.6° | C. | | |
| Phase Change | 0.4° | C. | | |
| Pinch Temperature | | | | |
| Refrigerant | 4.0 | kPa | | |

ΔP

As shown in FIG. 2, the heat exchangers are split into regions based on the phase of the organic working fluid (subcooled, two-phase, or superheated). Energy balance Equations (1.1) (1.3) are used to solve for the state points in each region.

$$\dot{Q} = \dot{m} \cdot ( {h}_{2} - {h}_{1} ) \qquad ( 1.1 )$$

$$\dot{Q} = \dot{m} \cdot {Cp}_{avg} ( {T}_{2} - {T}_{1} ) \qquad ( 1.2 )$$

$$\dot{Q} = ε \cdot {Cr}_{min} \cdot ( {T}_{hot , in} - {T}_{cold , in} ) \qquad ( 1.3 )$$

The total heat duty of heat exchangers with multiple flow regimes is the sum of the heat duties in each section. The recuperative heat exchangers did not have multiple regions since there is no working fluid phase change. The refrigerant side heat transfer is defined using Equation (1.1), while the liquid auxiliary streams used Equation (1.2). The minimum heat capacity rate is defined in Equation (1.4):

$${Cr}_{min} = min ( {\dot{m}}_{hot} \cdot {Cp}_{avg , hot} , {\dot{m}}_{cold} \cdot {Cp}_{avg , cold} ) \qquad ( 1.4 )$$

Specific heats are determined assuming the average temperature and pressure at the inlets and outlets of each section. When the refrigerant is a two-phase mixture, the specific heat is infinite and thus, the external stream heat capacity rate is always the minimum value. Specific heats for the external stream fluids are calculated with the average of the inlet and outlet temperatures. Isentropic efficiencies for the turbine, compressor, and pump are determined using Equations (1.5) and (1.6):

$${η}_{turb} = \frac{{h}_{in} - {h}_{out}}{{h}_{in} - {h}_{out , s}} \qquad ( 1.5 )$$

$${η}_{comp} , {η}_{pump} = \frac{{h}_{out , s} - {h}_{in}}{{h}_{out} - {h}_{in}} \qquad ( 1.6 )$$

The power generated from the turbine is calculated with Equation (1.7). The power consumed by the compressor and pump is calculated in Equations (1.8). The power transfer efficiency across the shaft from the expander to the compressor is calculated using Equation

$${\dot{W}}_{turb} = \dot{m} \cdot ( {h}_{in} - {h}_{out} ) \qquad ( 1.7 )$$

$${\dot{W}}_{comp} , {\dot{W}}_{pump} = \dot{m} \cdot ( {h}_{out} - {h}_{in} ) \qquad ( 1.8 )$$

$${η}_{shaft} = \frac{{\dot{W}}_{comp}}{{\dot{W}}_{turb}} \qquad ( 1.9 )$$

Using these equations, the thermodynamic model calculated the state points (temperature, pressure, and vapor quality) as shown in Table 2. The highest pressure on the power cycle (2281 kPa) and lowest pressure on the cooling cycle (256.8 kPa) are well within safe operating ranges. The low vapor quality at the evaporator inlet (0.0854) offers good thermodynamic performance because the evaporator can utilize almost all of the heat of vaporization from R1234ze(E). Thermal COP is the ratio of useful cooling output in the evaporator and amount of heat input to the waste heat boiler, determined using Equation (1.10).

$${COP}_{TH} = \frac{{\dot{Q}}_{evap}}{{\dot{Q}}_{boiler}} \qquad ( 1.1 )$$

The thermal efficiency of the organic Rankine power cycle is determined by dividing the net work output by the amount of heat input, as shown in Equation (1.11).

$${η}_{ORC} = \frac{{\dot{W}}_{turb} - {\dot{W}}_{pump}}{{\dot{Q}}_{boiler}} \qquad ( 1.11 )$$

The COP of the vapor compression cooling cycle is calculated by dividing the cooling output in the evaporator by the compressor power, as shown in Equation (1.12).

$${COP}_{VC} = \frac{{\dot{Q}}_{evap}}{{\dot{W}}_{comp}} \qquad ( 1.12 )$$

Finally, the energy balance, Equation (1.13), is calculated in accordance with the AHRI standard for water-cooled chillers.

$$Energy Balance = 100 \cdot ( 2 \cdot \frac{Energy In - Energy Out}{Energy In + Energy out} ) \qquad ( 1.13 )$$

TABLE 2
Baseline thermodynamic state points from ORVC simulation.

| | Power Cycle | | | Cooling Cycle | | |
|---|---|---|---|---|---|---|
| | Temper- | Pres- | | Temper- | Pres- | |
| State | ature | sure | Quality | ature | sure | Quality |
| Point | [° C.] | [kPa] | [—] | [° C.] | [kPa] | [—] |
| 1 | 89.80 | 2236 | Superheat | 31.06 | 256.8 | Superheat |
| 2 | 47.21 | 705.1 | Superheat | 65.04 | 699.6 | Superheat |
| 3 | 47.11 | 699.6 | Superheat | 64.96 | 694.1 | Superheat |
| 4 | 39.41 | 694.6 | Superheat | 46.83 | 688.5 | Superheat |
| 5 | 39.29 | 689.1 | Superheat | 46.73 | 683.1 | Superheat |
| 6 | 36.08 | 689.0 | 1 | 35.75 | 682.7 | 1 |
| 7 | 35.83 | 684.1 | 0 | 35.51 | 678.1 | 0 |
| 8 | 34.83 | 684.1 | Subcool | 34.51 | 678.1 | Subcool |
| 9 | 34.83 | 678.6 | Subcool | 34.51 | 672.6 | Subcool |
| 10 | 38.10 | 2281 | Subcool | 18.32 | 669.1 | Subcool |
| 11 | 38.10 | 2275 | Subcool | 18.32 | 663.6 | Subcool |
| 12 | 43.61 | 2270 | Subcool | 7.17 | 281.7 | 0.0854 |
| 13 | 43.61 | 2265 | Subcool | 6.60 | 276.2 | 0.0895 |
| 14 | 51.90 | 2258 | Subcool | 6.18 | 272.2 | 1 |
| 15 | 51.90 | 2253 | Subcool | 6.78 | 272.2 | Superheat |
| 16 | 85.37 | 2249 | 0 | 6.64 | 266.7 | Superheat |
| 17 | 85.23 | 2243 | 1 | 31.16 | 262.2 | Superheat |
| 18 | 89.90 | 2242 | Superheat | — | — | — |

Table 3 shows the simulation results for overall performance characteristics, heat exchanger heat duties, turbomachinery power, and the flow rates for refrigerant and the auxiliary streams. The thermal efficiency of the ORC is 8.1%, which is enhanced by the economizer and recuperator. These heat exchangers reduced the required heat input to the system by 10.9%. The SLHX provided a 16.1% increase to the evaporator cooling duty by providing additional subcooling prior to the throttling valve, which yielded a vapor compression cycle COP 6.32.

With these additional heat exchangers and high efficiency turbomachinery, the overall thermal COP of the ORVC chiller 304 is 0.653, which is competitive with state-of-the-art absorption chillers. Thermal COP of absorption chillers is generally limited to about 0.7 at similar operating conditions. The mass flow rates of the auxiliary loops are all achievable with standard centrifugal pumping machinery.

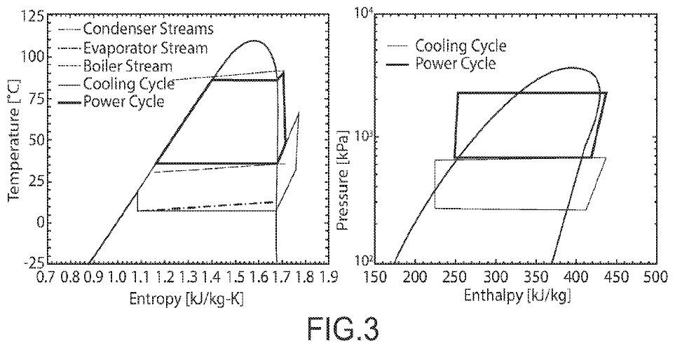

Finally, FIG. 3 shows the temperature to entropy (with external streams) and pressure to enthalpy diagrams for R1234ze(E), with the state points from Table 2 overlayed on the property plots. As shown in FIG. 3, the pressure ratio of the turbine is 3.17 and the pressure ratio of the compressor is 2.72, which are achievable for centrifugal machines at this scale.

TABLE 3
Baseline results from ORVC simulation.

| Calculated Model Value | Value | Calculated Model Value | Value | |
|---|---|---|---|---|
| COP_{TH} | 0.65 | \dot{Q}_{condenser, cooling cycle} | 313.5 | kW |
| COP_{ELEC} | 22.79 | Cooling cycle condenser | 0.18/0.81/0.95 | |
| | | SC/TP/SH ε | | |
| η_{ORC} | 8.10% | Evaporator TP/SH ε | 0.93/0.14 | |
| COP_{VCC} | 6.32 | \dot{Q}_{recuperator} | 22.12 | kW |
| Energy balance | 0.37% | \dot{Q}_{economizer} | 33.99 | kW |
| \dot{W}_{turb} | 50.34 kW | \dot{Q}_{SLHX} | 41.61 | kW |
| \dot{W}_{comp} | 47.47 kW | \dot{m}_{r, power cycle} | 2.79 | kg s⁻¹ |
| \dot{W}ₚᵤₘₚ | 13.16 kW | \dot{m}_{r, cooling cycle} | 1.83 | kg s⁻¹ |
| \dot{Q}_{boiler} | 458.8 kW | \dot{m}_{boiler} | 25.41 | kg s⁻¹ |
| Boiler SC/TP ε | 0.95/0.57 | \dot{m}_{condenser, power cycle} | 26.99 | kg s⁻¹ |
| \dot{Q}_{condenser, power cycle} | 455.6 kW | \dot{m}_{condenser, cooling cycle} | 18.57 | kg s⁻¹ |
| Power cycle condenser | 0.17/0.80/0.83 | \dot{m}ₑᵥₐₚₒᵣₐₜₒᵣ | 14.30 | kg s⁻¹ |

SC/TP/SH ε

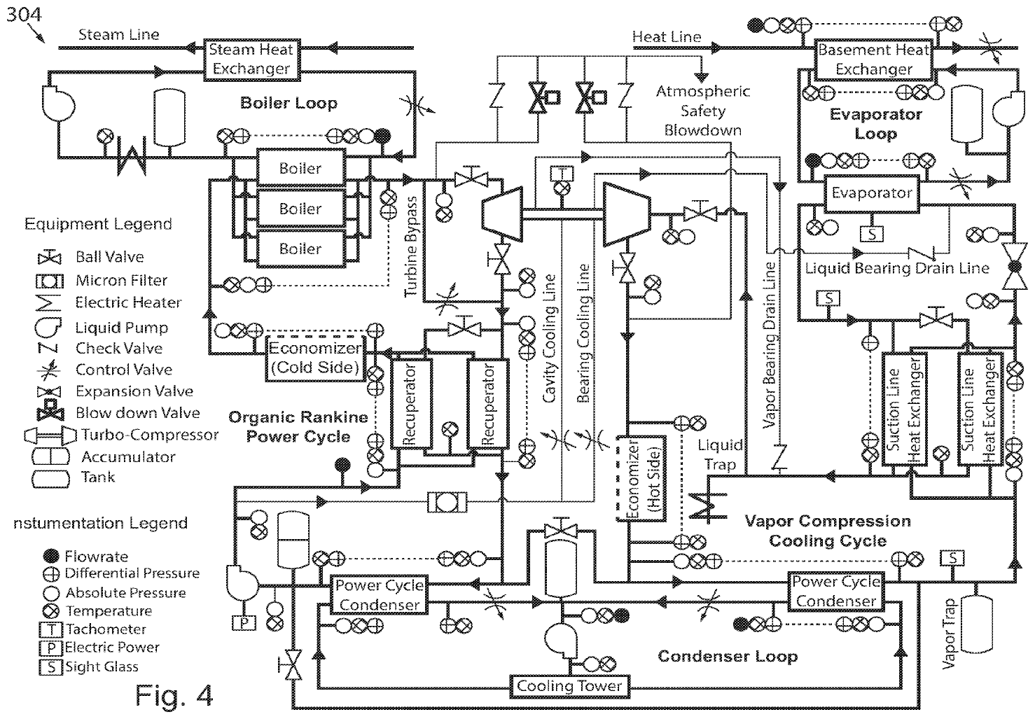

Referring to FIG. 4, a piping and instrumentation diagram of the experimental ORVC chiller 304 is shown. Compact, aluminum brazed heat exchangers are custom fabricated by, for example, Modine Manufacturing Co., for the boilers, recuperators, SLHXs, and economizer. Three boiler cores are connected in parallel in the organic Rankine cycle. Similarly, two cores connected in parallel are used for the SLHX and recuperator in the system. Commercially available shell and tube heat exchangers are selected for the power cycle condenser, cooling cycle condenser, and evaporator. The tube side of the condensers and evaporator use liquid glycol (or water) while the shell side contained the R1234ze(E) refrigerant. The turbo-compressor, fabricated by, for example, Barber-Nichols Inc., is a high-speed radial turbine and centrifugal compressor supported by refrigerant cooled ball bearings. The turbine and compressor are directly coupled to the same shaft and designed to operate at 31 kRPM. The power cycle pump is a six-stage side channel pump with a radial vane suction impeller and driven by a 19 kW three pole motor. The motor is controlled by a variable frequency drive (VFD) to modulate the rotational speed of the pump and the flow rate through the power cycle.

The ORVC chiller 304 is 5.28 m in length, 1.75 m in width, and 2.84 m in height with a wet mass just under 7,000 kg (water, glycol, and refrigerant).

Three auxiliary systems are required to characterize the performance of the ORVC chiller 304: waste heat boiler loop, condenser cooling glycol loop, and evaporator chilled water loop (FIG. 4). In the waste heat loop, 50% by volume ethylene glycol and water is pumped through three boiler cores connected in parallel. The glycol mixture is heated using a natural gas-fired steam boiler and six electric heaters. The heat energy from the power and cooling cycle condensers is rejected to 50% by volume ethylene glycol and water in the condenser loop. The heat is finally rejected to the ambient in a hybrid evaporative cooling tower, which sprayed water on coils containing the glycol. A Proportional-Integral-Derivative (PID) controller on the cooling tower fan variable frequency drive maintained the temperature of the glycol mixture supplied to the condensers. A stream of pure water is pumped through the evaporator and cooled by the evaporating refrigerant in the vapor compression cycle. After being cooled, the water is re-heated in a heat exchanger which had a 50% by volume propylene glycol and water mixture at 60° C. on the other side. The propylene glycol-water mixture is maintained at 60° C. by a natural gas heater.

The ORVC chiller 304 is built and tested at 300 kW scale to validate the performance of the turbomachinery, which is a critical enabling component. The isentropic efficiency targets in this work (greater than 80%) are extremely aggressive for centrifugal turbomachinery at this size. The turbine and compressor wheel diameters are approximately 130 mm. The isentropic efficiency of centrifugal machines gets lower as the size of the wheel is decreased due to the larger ratio of tip clearance to wheel diameter. As the machine gets smaller, a larger portion of flow can “leak” around the wheel and will degrade machine performance. The tip clearances are a fixed value based on modern manufacturing techniques. Any smaller scale turbomachinery would not have been able to meet high isentropic efficiency targets.

### Data and Results

The performance characterization followed Air-Conditioning Heating and Refrigeration Institute performance rating standards for commercial water-cooled vapor compression chillers and water-cooled, hot water driven absorption chillers to evaluate the baseline performance. These standards rate performance using temperature, pressure, and flow rate measurements of the external streams during system operation. Uncertainty, accuracy, and stability of each measurement must be within boundaries specified by these standards. Measurements are also taken on the refrigerant side of the ORVC chiller 304 to validate performance predictions from the simulation effort.

Temperature, pressure, flow, rotational speed, and power consumption measurements are taken at the locations shown in FIG. 4 for the ORVC chiller 304. The ranges of calibration biases for the instruments are presented in Table 4. Temperature is measured with calibrated Type-T thermocouples directly inserted into the flow path. The mass flow of the power cycle is measured using, for example, a Krohne Optimass 7000 Coriolis mass flow meter. The pressure drop across heat exchangers is measured with Dwyer 3100D differential pressure transducers. The speed of the turbo-compressor is measured with a proximity sensor on the shaft. Pressure is measured with, for example, calibrated ifm Efector PX32 series pressure transmitters. The pressures at fluid phase transition state points within the heat exchangers are estimated from experimental data assuming equal distribution of pressure drop among the phases. These pressures are then used to determine refrigerant saturation temperatures with REFPROP. Temperatures (or vapor mass qualities) and pressures at each state point within the system are then used to determine enthalpy with REFPROP. The REFPROP equations of state by Akasaka for R1234ze(E) are used in the study. Due to challenges with the original mass flow meter on the cooling cycle, the refrigerant mass flow is calculated with an energy balance on the economizer, assuming the heat loss is negligible. Flow in the auxiliary loops is measured directly with, for example, Badger SDI turbine paddle-wheel style flow meters.

TABLE 4
Test loop instrumentation technical specifications.

| Instrument Locations | Bias Error± | Accuracy Range |
|---|---|---|
| Thermocouple [° C.] | | |
| ORVC power and cooling cycle | 0.049 to 0.13 | 0.5 to 95 |
| Boiler loop | 0.058 to 0.075 | 40 to 120 |
| Condenser loop | 0.039 to 0.061 | 12.8 to 45.6 |
| Evaporator loop | 0.019 to 0.035 | 2.2 to 32.2 |
| Pressure Transmitter [kPa] | | |
| Power cycle high side | 3.81 to 4.36 | 3,547 |
| (pump outlet to turbine | | |
| inlet) | | |
| Cooling cycle low side | 0.95 to 1.4 | 789 |
| (throttle valve outlet to | | |
| compressor inlet) and | | |
| external loops | | |
| Power cycle low side, | 1.27 to 1.50 | 1,134 |
| cooling cycle high side | | |
| Differential Pressure | | |
| Transmitter [kPa] | | |
| ORVC power and cooling | 0.12 | 0 to 37.33 |
| cycle and boiler glycol | | |
| Condenser glycol, chilled | 0.61 | 0 to 186.6 |
| water lines | | |
| Flow Meter [m³ hr⁻¹] | | |
| Boiler loop and condenser | 1% of reading | 9.08 to 181 |
| loop | | |
| Evaporator loop | 1% of reading | 3.41 to 68. |
| Power cycle [kg s⁻¹] | 0.1% of reading + | 0 to 4.06 |
| | 6.1E−4 | |
| Power Consumption [kW] | | |
| Power cycle pump | 2% of reading | 4.99 to 49.88 |
| Rotational Speed [kRPM] | | |
| Turbo-compressor shaft | <1% of reading | 0.01 to 100 |

The pressure transmitters and thermocouples are calibrated over ranges of values relevant for the investigation (Table 4). Calibration of each instrument is performed following the standard error of linear regression method from ASME PTC 19.1-2018. The calibration standard for the thermocouples is a 5615 Hart Scientific platinum resistance thermometer with a bias of ±0.013° C. while the pressure transmitter standard is an Ametek Type T deadweight tester with a bias of ±0.1% of the measurement range. All instruments are installed in accordance with manufacturer specifications and met bias requirements outlined in the performance rating standards. In addition to the bias requirements, the AHRI standards require data to meet several stability and accuracy criteria to ensure the fidelity of the performance characterization, which are as follows:
Condenser inlet temperature, evaporator outlet temperature mean values within 0.28° C. of baseline
Condenser inlet temperature, evaporator outlet temperature standard deviation <0.1° C.
Ratio of standard deviation to mean <0.75% for condenser and evaporator flow rates
Boiler inlet temperature cannot deviate more than 3° C. from baseline
The auxiliary loop flow rates must not deviate more than 5% from the baseline.
15-minute test length with data taken at least every 30 s.
Absolute value of energy balance must be below 3.69%

A full uncertainty analysis is also performed on the measurements and the performance metrics via the standard method of error propagation to further ensure the quality of the data.

Once steady-state operation is achieved, data is collected over a fifteen-minute interval at a sampling frequency of 2 Hz to quantify baseline performance characteristics and validate modeling results for the ORVC chiller 304. The data set test length and sample rate conformed to the performance rating requirements. Table 5 shows the temperatures, flow rates, inlet pressures, and differential pressures of the external stream heat exchangers over the test period. For each measured variable, the total uncertainty is <1% greater than the respective bias errors due to low systematic uncertainties. Flow and temperature stability and precision for the external loops also conformed to the criteria presented in the previous section, except for the condenser glycol loop flow rate. Although the condenser mass flow rate is 25.6% below the target value, the flow rate did meet the stability criteria for ratio of standard deviation and mean. The condenser loop pump could not overcome the prohibitive frictional pressure losses in the cooling tower supply and return lines. The flow rate limitation affected system performance.

TABLE 5
Auxiliary loop state points at the inlet and outlet of each heat exchanger.

| | Inlet | Outlet | Inlet | Differential | Mass |
|---|---|---|---|---|---|
| Heat | Temperature | Temperature | Pressure | Pressure | Flow Rate |
| Exchanger | [° C.] | [° C.] | [kPa] | [kPa] | [kg s⁻¹] |
| Boiler | 91.18 ± 0.07 | 86.24 ± 0.07 | 350.8 ± 0.99 | 33.13 ± 0.12 | 27.23 ± 0.27 |
| Power | 29.91 ± 0.06 | 36.58 ± 0.06 | 320.9 ± 1.10 | 62.05 ± 0.61 | 19.78 ± 0.35 |
| Condenser | | | | | |
| Cooling | 30.05 ± 0.05 | 36.82 ± 0.04 | 317.9 ± 0.96 | 62.55 ± 0.61 | 13.05 ± 0.13 |
| Condenser | | | | | |
| Evaporator | 12.12 ± 0.04 | 6.996 ± 0.027 | 526.4 ± 0.98 | 34.64 ± 0.61 | 12.27 ± 0.12 |

Table 6 shows the 15-minute average state points of the refrigerant. Corrections are made to the state points at the evaporator outlet and the cooling cycle condenser outlet to enable performance calculations. The temperature measurement at the evaporator outlet is too close to the saturation line and erroneously returned subcooled liquid properties when using REFPROP. Thus, the evaporator refrigerant outlet enthalpy (cooling cycle state point 15) is calculated from the absolute pressure and assuming the fluid is a saturated vapor. The sole presence of vapor is visually confirmed using a sight glass at the evaporator outlet. The refrigerant exiting the cooling cycle condenser is two-phase and thus, the transition from two-phase to saturated liquid (cooling cycle state point 7 in FIG. 2) occurred in the SLHX. The two-phase condition at the outlet of the condenser is visually confirmed in a sight glass. The true SLHX inlet enthalpy is determined by performing an energy balance on the device. Assuming heat loss is negligible, the corrected enthalpy is also applied at the cooling cycle condenser outlet.

TABLE 6
Experimentally determined state points with R1234ze(E).

| | Power Cycle | | | | Cooling Cycle | | | |
|---|---|---|---|---|---|---|---|---|
| State | Temperature | Pressure | Enthalpy | Quality | Temperature | Pressure | Enthalpy | Quality |
| Point | [° C.] | [kPa] | [kJ kg⁻¹] | [—] | [° C.] | [kPa] | [kJ kg⁻¹] | [—] |
| 1 | 90.22 | 2241 | 437.9 | Superheat | 35.69 | 244.6 | 416.5 | Superheat |
| 2 | 50.45 | 743.3 | 422.0 | Superheat | 73.29 | 759.5 | 445.6 | Superheat |
| 3 | 50.49 | 743.0 | 422.1 | Superheat | 73.20 | 759.5 | 445.5 | Superheat |
| 4 | 39.28 | 731.3 | 410.5 | Superheat | 47.40 | 745.8 | 418.8 | Superheat |
| 5 | 39.08 | 731.4 | 410.3 | Superheat | 47.26 | 722.8 | 419.1 | Superheat |
| 6 | 37.97 | 725.2 | 409.2 | 1 | 37.56 | 717.0 | 409.0 | 1 |
| 7 | 37.66 | 718.9 | 252.3 | 0 | — | — | — | — |
| 8 | 35.26 | 712.7 | 248.8 | Subcool | 36.84 | 705.4 | 261.1 | 0.0621 |
| 9 | 35.36 | 724.6 | 249.0 | Subcool | 36.62 | 708.0 | 261.1 | 0.0609 |
| 10 | 38.34 | 2459 | 253.3 | Subcool | 24.14 | 701.8 | 233.1 | 0 |
| 11 | 38.42 | 2364 | 253.4 | Subcool | 24.14 | 710.7 | 233.1 | 0 |
| 12 | 46.15 | 2355 | 264.6 | Subcool | 21.74 | 463.9 | 233.1 | 0.1327 |
| 13 | 46.15 | 2302 | 264.6 | Subcool | 6.03 | 269.0 | 233.1 | 0.1383 |
| 14 | 56.09 | 2294 | 279.3 | Subcool | 6.03 | 269.0 | 388.5 | 1 |
| 15 | 56.06 | 2299 | 279.3 | Subcool | 5.72 | 269.0 | 388.5 | Superheat |
| 16 | 86.17 | 2287 | 329.2 | 0 | 5.72 | 269.0 | 388.5 | Superheat |
| 17 | 85.92 | 2275 | 429.8 | 1 | 35.85 | 250.3 | 416.5 | Superheat |
| 18 | 90.83 | 2263 | 438.3 | Superheat | — | — | — | — |

Overall performance metrics are calculated with the refrigerant state points and auxiliary loop state points from a 15-minute steady state data point. As shown in Table 7, the data verified that the energy balance (3.08%) met the AHRI standards (±3.69%). The 3.08% energy loss in this experiment is likely due to natural convection from the hot surfaces of the heat exchangers.

TABLE 7
Performance metrics from experimental demonstration.

| Experimental Performance | Value |
|---|---|
| \dot{Q}_{boiler} [kW] | 473.0 ± 10.6 |
| \dot{Q}_{condenser, power cycle} [kW] | 435.7 ± 9.5 |
| \dot{Q}_{condenser, cooling cycle} [kW] | 291.8 ± 4.0 |
| \dot{Q}ₑᵥₐₚₒᵣₐₜₒᵣ [kW] | 263.8 ± 3.5 |
| \dot{m}_{r, power cycle} [kg s⁻¹] | 3.15 ± 0.004 |
| \dot{m}_{r, cooling cycle} [kg s⁻¹] | 1.74 ± 0.016 |
| \dot{W}_{turb} [kW] | 50.07 ± 0.57 |
| \dot{W}_{comp} [kW] | 50.24 ± 0.48 |
| η_{shaft} [%] | 100.3 ± 1.5 |
| η_{turb} [%] | 76.70 ± 0.90 |
| η_{comp} [%] | 84.75 ± 0.54 |
| \dot{W}ₚᵤₘₚ [kW] | 13.53 ± 0.41 |
| ηₚᵤₘₚ [%] | 35.64 ± 1.10 |
| \dot{W}_{pump, elec} [kW] | 13.62 ± 0.27 |
| Turbo-compressor speed [kRPM] | 31.5± 0.3 |
| COP_{TH} [—] | 0.56 ± 0.01 |
| COP_{ELEC} [—] | 19.37 ± 0.46 |
| Energy Balance [%] | 3.08 ± 1.98 |
| η_{ORC} [%] | 7.71 ± 0.22 |
| COP_{VC} [—] | 5.23 ± 0.09 |

The heat input in the boiler is 473 kW±10.6 kW and the cooling duty in the evaporator is 263.8 kW±3.5 kW which yielded an overall thermal COP of 0.56±0.01. The goal during testing is to achieve the 300 kW of cooling duty from the design point, which required a higher heat input than the design point. The turbine and compressor operated at 31.5 kPRM±0.3 kRPM, with a power transfer efficiency of 100.3%±1.5%. The power transfer efficiency between turbine and compressor is quite high, which is likely due to the very low windage and bearing losses from the careful design of the rotating wheels direct coupling between the rotating wheels.

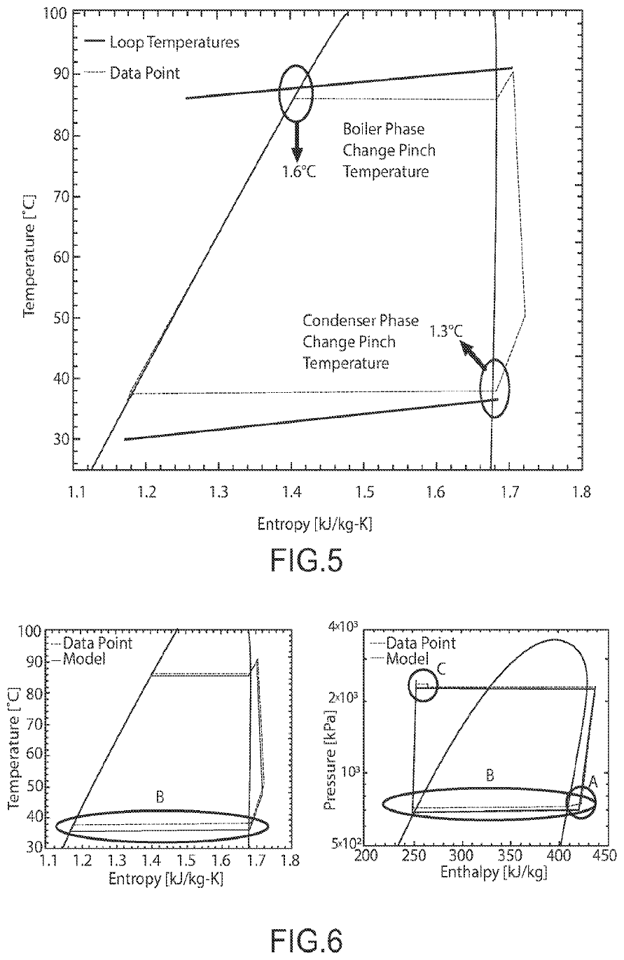

The experimental results of the power cycle are shown in FIG. 5 on a T-s diagram with the external temperature streams overlaid. The boiler phase change pinch point temperature is lower than the design point (1.6° C. experimental vs. 2.3° C. model) and the condenser phase change pinch points are very close to the design (1.3° C. experimental vs. 1.2° C. model for the condenser). The experimental flow rate of refrigerant through the power cycle (3.15 kg s⁻¹) is substantially greater than the design flow rate (2.79 kg s⁻¹), suggesting the turbine needed more flow to achieve the power output needed, including power required by the compressor. The turbine isentropic efficiency is lower than expected (76.70% experimental vs. 83.10% model) and the compressor pressure ratio is higher than expected (3.10 experimental vs. 2.73 model) due to higher refrigerant pressure losses throughout the cooling cycle, thus requiring additional power to provide cooling at the target chilled water temperatures. During testing, increased power cycle pump speed yielded greater boiler saturation pressures instead of increased mass flow rate, suggesting flow is choked in the turbine. Since the flow is choked, this condition represented the maximum achievable turbine power output and thus, the maximum amount of cooling duty provided by the evaporator. In addition, flow choking prevented any further increases in heat input to the boiler. The power cycle pump consumed 13.53 kW±0.41 kW to pressurize the refrigerant with an isentropic efficiency of 35.64%±1.10%.

FIG. 6 shows a comparison between the T-s and P-h diagrams of the ORC, where the experimental data is plotted in a dashed line and the baseline modeling is shown as a solid line. Higher power cycle refrigerant flow rate is required to meet the power demands because of the reduced turbine isentropic efficiency, which also reduced the enthalpy drop across the device (15.92 kJ kg⁻¹ experimental vs. 18.03 kJ kg⁻¹ model), which is represented by Item A in FIG. 6. Additionally, the pressure ratio of the turbine is lower than expected (3.02 vs. 3.17) because of the higher saturation temperature in the condenser. Since the turbine directly powered the compressor, the decreased turbine performance also impacted the compressor power and the performance of the cooling cycle. The lower-than-design flow rate in the glycol lines of the condenser increased low side saturation pressure (and temperature) in the power cycle condenser (item B in FIG. 6), which decreased the turbine pressure ratio. There are also more significant pressure losses in the power cycle compared to the modeling prediction (item C in FIG. 6). The pressure loss in the refrigerant lines from the power cycle pump to the recuperator and from the recuperator to the economizer are much larger than anticipated. These values are 95.5 kPa, and 53.1 kPa, respectively, compared to the modeled value of 5.48 kPa. The additional pressure drop is likely due to the much higher experimental flow rate (3.15 kg s⁻¹) than the model (2.79 kg s⁻¹). In addition, some of the added pressure drop in the power cycle pump to recuperator piping is due to the Krohne Coriolis mass flow meter.

The heat input in the boiler is 473 kW±10.6 kW and the power output of the turbine is 50.07 kW±0.57 kW. Accounting for the power cycle pump energy consumption resulted in an ORC efficiency of 7.71%±0.22%, which is slightly lower than the modeled value of 8.1%. The reduced ORC performance also impacted the efficiency and performance of the vapor compression cooling cycle.

The economizer is located right after the recuperator on the power cycle and at the discharge of the compressor on the cooling cycle. The high temperature compressor discharge (73.3° C.) preheated the power cycle fluid 330 after the recuperator (46.2° C.). The refrigerant enthalpy in the power cycle rose from 264.6 kJ kg⁻¹ to 279.3 kJ kg⁻¹ through the economizer at a mass flow rate of 3.15 kg s⁻¹, which yielded a heat input from the economizer of 46.3 kW to the power cycle fluid 330 just before the waste heat boiler cores. If the economizer was not included in the system, 46.3 kW of additional heat energy would have to be input to the system to operate at the same conditions. Thus, the heat input of 473 kW would have been increased to 519.3 and the thermal efficiency of the ORC would have decreased from 7.7% to 7.0%. The overall COP of the ORVC chiller 304 would decrease from 0.56 to 0.51.

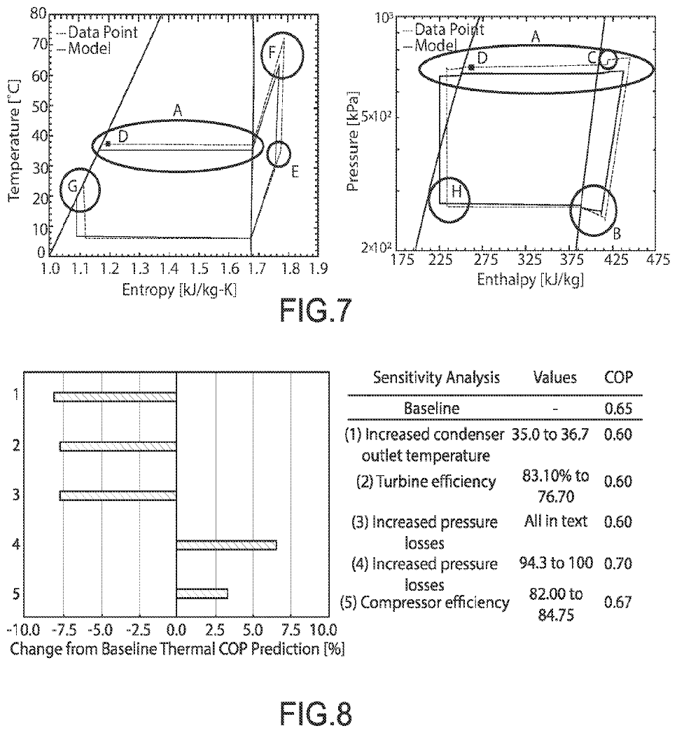

FIG. 7 shows the experimental and model predicted cooling cycle state points on T-s and P-h diagrams, where the experimental data is plotted in a dashed line and the baseline modeling is shown as a solid line. The condensing saturation pressure (and temperature) is higher than the model predicted value (item A in FIG. 7). In contrast to the turbine, the elevated high side pressure increased the pressure ratio across the compressor (3.10 experimental vs. 2.73 model), which increases the enthalpy rise relative to the baseline (29.08 kJ kg⁻¹ experimental vs. 25.97 kJ kg⁻¹ model). The higher enthalpy rise decreased the flow rate delivered by the device (1.74 kg s⁻¹ experimental vs. 1.83 kg s⁻¹ model), which had a negative impact on the amount of chilling provided in the evaporator. The pressure ratio of the compressor is further increased by increased pressure loss (18.7 kPa experimental vs. 4.50 kPa model) in the vapor side of the SLHX (item B in FIG. 7) and a higher-than-expected pressure loss (22.9 kPa experimental vs. 5.48 kPa model) in the piping between the economizer vapor outlet and cooling cycle condenser inlet (item C in FIG. 7). While not noticeable on the phase diagrams, the improved compressor and shaft efficiencies over the baseline prediction helps to counteract some of these challenges. The compressor efficiency is 84.75% in experimental testing compared to 82.00% in the modeling design point. The shaft efficiency is 100.3% in the experimentation compared to 94.30% in the simulations.

The refrigerant leaving the cooling condenser (item D in FIG. 7) is a two-phase mixture and not fully subcooled, which further degraded the performance of the cooling cycle. Since the SLHX is in a counter flow orientation, the two-phase fluid entering the high temperature side of the device increased the average temperature difference for energy exchange over the design point value. The higher temperature difference and elevated condenser saturation temperature increased the SLHX vapor discharge temperature over the baseline (35.85° C. experimental vs. 31.16° C. model) as shown in item E in FIG. 7. Higher vapor outlet temperature from the SLHX and higher compressor discharge pressure from the condenser saturation temperature elevated the compressor discharge temperature over the baseline value (73.29° C. experimental vs. 65.04° C. model). The higher discharge temperature and pressure (item F in FIG. 7) increased the heat duty of the economizer (46.38 kW vs. 33.99 KW). Since the condenser glycol pump could not deliver the design point flow rate, the higher temperature of the condenser outlet reduced subcooling in the SLHX (item G in FIG. 7) and increased the vapor mass quality entering the evaporator (13.83% vs. 8.954%). The increased quality at the evaporator inlet decreased the enthalpy change (155.5 kJ kg⁻¹ experimental vs. 164.2 kJ kg⁻¹ model) across the evaporator (item H in FIG. 7) which reduced the cooling duty. Item H in FIG. 7 shows that the evaporator refrigerant inlet saturation pressure and temperature are less than the design (6.03° C. vs. 6.60° C.). However, the evaporator pinch temperature is only slightly greater than that predicted by the manufacturer (0.97° C. vs. 0.4° C.), meaning that the device is performing closely to the design predictions.

On the liquid side, SLHX increases the amount of subcooling prior to the evaporator inlet. The inlet quality to the evaporator is reduced, which provides a performance boost as more enthalpy of vaporization is available to provide the useful chilling effect in the evaporator. Through the SLHX, the enthalpy of the liquid stream decreases from 261.1 kJ kg⁻¹ to 233.1 kJ kg⁻¹. With a mass flow of 1.74 kg s⁻¹, this yields a 48.7 kW increase in cooling capacity. Without the SLHX, the cooling capacity from the evaporator would have been 215.1 kW, an 18.5% decrease from the 263.8 kW experimental chilling capacity. The overall COP of the ORVC chiller 304 would then decrease from 0.56 to 0.45. The SLHX also increases the inlet temperature of the compressor, which would typically increase the load of the condenser. This phenomenon is avoided by integrating an economizing heat exchanger that captured the additional sensible energy at compressor discharge and transferred it to the power cycle.

The cooling duty in the evaporator is 263.8 kW±3.5 kW, which is lower than the design point target of 300 kW. The compressor consumed 50.41 kW±0.48 kW of power, which is higher than the turbine power provided, but within measurement error. The vapor compression cycle COP is then 5.23±0.09, which is competitive with state-of-the-art vapor compression chillers.

The overall COP of the ORVC chiller 304 is 0.56±0.01, which is lower than the model predicted value of 0.65. The increased evaporator vapor quality directly reduced the amount of cooling duty. The factors discussed above (lower than design condenser glycol flow rate, choked flow in the turbine, and higher than design pressure losses) contributed to the lowered COP of the system. To analyze the impact of individual inputs on overall system performance, a sensitivity analysis is conducted on the baseline thermodynamic performance model as shown in FIG. 8. The variables included in the sensitivity study are the condenser glycol flow rate, turbine, compressor and shaft efficiencies, and pressure losses. For each sensitivity analysis, a single input is updated in the model, with all other inputs remaining the same as previously modeled, and the impact on full system performance is quantified.

Since the condenser glycol pump could not deliver the design point flow rate, the outlet temperature of the glycol mixture from the condensers is higher in the experimental testing than the design point simulations. The average condenser glycol mixture outlet temperature is 36.7° C. instead of the target value of 35.0° C., which detrimentally impacted the performance of the full system. When the thermodynamic model is updated to have a 36.7° C. condenser outlet temperature, the saturation pressure of the refrigerant in the condenser increased. The increased saturation pressure caused an increase in the enthalpy rise across the compressor (27.3 kJ kg⁻¹ compared to 26.0 kJ kg⁻¹). The higher compressor pressure ratio increased the power requirement from the turbine (from 47.47 kW to 50.08 KW) since the chilling duty is a fixed input to the model. The turbine enthalpy drop decreased due to the higher saturation pressure in the condenser (18.0 kJ kg⁻¹ to 17.3 kJ kg⁻¹). As a result, the power cycle mass flow is higher to satisfy the greater power demand (from 2.79 kg s⁻¹ to 3.07 kg s⁻¹), which is similar to mass flow rate experienced during testing. Additionally, the compressor inlet temperature and outlet temperature increased to 32.45° C. and 67.98° C. relative to the baseline values of 31.06° C. and 65.04° C., respectively. The cumulative impacts of reduced condenser flow rate results in an 8.1% decrease in thermal COP, as shown in FIG. 8.

The experimental differences in turbine, compressor, and shaft efficiencies had significant impact on the system performance. When the turbine efficiency is reduced from the modeled value of 83.10% to the experimental value of 76.70% in the baseline simulation, the power cycle mass flow increased to 3.02 kg s⁻¹ to maintain cooling duty, while the thermal COP decreased by 7.7%. The higher flow rate maintained the power output of the turbine despite the decreased efficiency. When the compressor efficiency is increased to the experimental value of 84.75% (from 82.00%), thermal COP is increased by 3.3%. The power transfer efficiency is more impactful on full system performance than the compressor efficiency. Although the measurements are within experimental error, a near-perfect shaft efficiency is measured in the experiments (100.3%±1.5%), which suggested the manufacturer overestimated the losses of the turbo-compressor. Assuming a shaft efficiency of 100% in the baseline model (where the original prediction is 94.3%) increased thermal COP by 6.5%.

FIG. 8 shows the effects of the following experimental refrigerant pressure drops: SLHX vapor side, cooling cycle economizer to condenser inlet piping, power cycle pump outlet to recuperator liquid inlet, and power cycle recuperator liquid outlet to power cycle economizer liquid inlet piping. The increased pressure drops are input to the baseline simulation individually and the decrease in thermal COP is documented. The SLHX vapor pressure drop is measured at 18.7 kPa, which is significantly higher than the 4.50 kPa pressure drop in the simulation. When the vapor pressure drop is increased in the simulation, the thermal COP decreased by 5.7% which is the largest individual impact of the pressure drops. Any pressure loss in the SLHX vapor side must be immediately overcome by the compressor, which directly increases the power requirement. The SLHX vapor pressure drop had such a large individual impact because the absolute pressure is <300 kPa. Thus, the pressure drop of 18.7 kPa represents a 7% loss in operating pressure. In comparison, 7% loss in operating pressure on the high side of the power cycle would be 171 kPa. It is very important to carefully design the heat exchangers on the low-pressure parts of the cycle because very small pressure drop can have significant ramifications. The experimentally measured pressure drop from the cooling cycle economizer to the cooling cycle condenser inlet is 22.9 kPa, compared to the simulation value of 5.48 kPa. The higher pressure drop in this line decreased the thermal COP by 2.3%.

The piping run from the power cycle pump outlet to the liquid recuperator inlet had an experimental pressure drop of 95.5 kPa, which is almost 20 times higher than the modeled value of 5.48 kPa. Although this pressure drop is so much higher than expected, it only caused a 0.5% decrease in the thermal COP. The small impact on thermal COP is likely because 95.5 kPa pressure drop is a much smaller fraction of the absolute pressure (2,459 kPa) compared to the pressure drop and absolute pressure in the SLHX vapor line, and pump work requirement does not impact thermal COP. The final line loss that is examined in the sensitivity analysis is the pressure drop in the power cycle from the recuperator liquid outlet to the economizer liquid inlet. In the piping from the recuperator to the economizer, the pressure drop is 53.1 kPa, compared to the experimental value of 5.48. When the additional pressure drop is incorporated into the simulation, the thermal COP decreased by 0.3%.

The liquid pressure losses in the lines between the pump and economizer on the power cycle marginally affect thermal performance. The vapor pressure loss through the SLHX is twice as impactful as the pressure loss from the economizer to cooling condenser connection although both values should be addressed to improve thermal performance. When all four increased pressure drops are included in the simulation, the thermal COP decreased by 7.7%, which is the second most impactful variable in the sensitivity study.

The baseline performance model is updated to determine the efficiency and cooling duty achievable using the current turbo-compressor design, but with original estimates for pressure drop and condenser saturation temperatures. Updating the turbine, compressor, and shaft efficiencies to 76.70%, 84.75%, and 100% in the baseline model showed 300 kW of cooling is produced with a thermal COP of 0.66. The power cycle mass flow at this operating condition is 2.76 kg s⁻¹, suggesting the cooling duty would not be limited by flow choking in the turbine. Moving away from choked flow could increase the turbine efficiency and further improve the COP of the ORVC chiller 304.

A ORVC chiller 304 chiller is designed, built, and tested at standard rating conditions to provide a comparison to LiBr-water absorption chillers. A thermodynamic simulation of the ORVC chiller 304 is solved in Engineering Equation Solver and an experimental model is built and tested to validate the simulations. The model used high-speed turbomachinery, compact heat exchangers, novel methods of heat recuperation, and a next generation, low-GWP working fluid R1234ze(E).

The model achieved a thermal COP of 0.56 with a waste heat driving temperature of 91° C., a chilled water outlet temperature of 7° C., and a condenser heat rejection temperature at 30° C. The ORVC chiller 304 generated 263.8 kW of chilled water with 473 kW of heat input from hot glycol. A cooling capacity of 264 kW±3.5 kW is experimentally validated with a COP of 0.56±0.01 during steady-state operation at the design temperatures. The thermal efficiency, accounting for pump work, of the Rankine cycle is 7.7%±0.22% and the COP of the vapor compression cycle is 5.25±0.09. The centrifugal turbo-compressor operated at 31.5 kRPM±0.3 kRPM, with a turbine and compressor isentropic efficiencies of 76.7%±0.90% and 84.8%±0.54%, respectively, with near-perfect power transmission between these components.

The thermodynamic performance is competitive with commercially available LiBr absorption chillers which typically have COP ranging from 0.55 to 0.77. The turbine had a lower-than-expected isentropic efficiency (76.7% vs. 83.1%), but the compressor efficiency is higher than expected (84.75% vs. 82.0%). In addition, the experimentally measured shaft efficiency is 100.3%, which is higher than the design point shaft efficiency of 94.3%. When the experimental turbomachinery efficiencies are updated in the baseline model, the thermal COP increased to 0.66 and the power cycle mass flow is below the choked flow condition in the turbine. Sensitivity analysis showed that the temperature of the condenser glycol had the largest detrimental impact on the COP of the ORVC chiller 304. The next most impactful factors are the decreased turbine efficiency and the high pressure losses throughout piping and heat exchangers.

### Example 2: Modular ORVC Chiller with Evaporative Condenser

Referring to FIGS. 9 to 15, process flow diagrams of a modular ORVC system 404 of the present invention is shown. The modular ORVC system 404 design incorporates a modular chiller system with evaporative condenser 100 to provide direct heat transfer to the ambient.

The modular ORVC system 404 consists of two integrated thermodynamic cycles, a power cycle 416 and a cooling cycle 418, that are linked by a high efficiency turbo-compressor 420 and compact heat exchanger technology. The modular ORVC system 404 links the organic Rankine power cycle 416 and a vapor compression cooling cycle 418 using a turbine 432 and compressor 434 that shares a single shaft 436 but uses an evaporative condenser 100 to provide a single heat rejection process which involves the evaporation of heated water from the external surface of the coolant tubing.

The evaporative condenser 100 uses a single heat rejection process which involves the evaporation of heated water from the external surface of the coolant tubing or condensing coil 102. In contrast, for chiller systems that utilize a cooling tower, for example, as seen in FIG. 4, heat transfer from the cooling process involves two stages. The heat generated by an industrial or commercial process is first transferred to the circulating chilled working fluid by the condenser before a second step of atmospheric heat rejection at the cooling tower. Thus, they require water-cooled condensers, water circulation pumps, and piping to off-site cooling towers which are eliminated in the presently described modular ORVC system 404.

Therefore, the present invention provides a modular ORVC system 404 or turbo-compression cooling system (“TCCS”), which provides an all-in-one solution which offers optimized performance; reduces design, assembly and installation complexity and costs; reduces lead time with minimal on-site construction; reduces footprint and volume; and is scalable and movable.

Referring to the embodiment shown in FIG. 9, in the power cycle 416, high pressure refrigerant 430, e.g., R1234ze(E), leaving the evaporative condenser 100 (or evaporative condenser 100a) is pressurized by a low power pump 424 and subsequently vaporized and superheated in a boiling heat exchanger or waste heat boiler 428 by absorbing thermal energy from the high temperature glycol stream. The waste heat boiler 428 is supplied heat via the jacket water and lubricating oil that is used to cool the diesel generators. In particular, the jacket water and lubricating oil provide heat to the fluid in the power cycle 416 after it has been heated by the diesel generators. By rejecting the heat from the jacket water and lubricating oil to the fluid in the power cycle 416, the jacket water and lubricating oil is thereby cooled, and converting this heat to cooling increases the efficiency of the overall system, generally.

Then, the high pressure, vaporized power cycle refrigerant 430 is expanded to a low pressure in the radial turbine 432 to produce mechanical power, which directly powers the centrifugal compressor 434 on the vapor compression cooling cycle 418. The power cycle refrigerant 430 leaving the turbine 432 exchanges heat with the power cycle refrigerant 430 exiting the power cycle pump 424 in the evaporative condenser 100 (or evaporative condenser 100a).

The power cycle refrigerant 430 is fully liquefied and subcooled in the evaporative condenser 100 (or evaporative condenser 100a) and pressurized through the power cycle pump 424. Upon exiting the turbine 432, the power cycle refrigerant 430 enters the evaporative condenser 100 (or evaporative condenser 100a). In certain embodiments, the evaporative condenser 100 (or evaporative condenser 100a) may receive the power cycle refrigerant 430 within a closed circuit refrigerant tubing or condensing coil 102 by which the power cycle refrigerant 430 is converted from a heated vapor to a cooled liquid form. In certain embodiments, power cycle refrigerant 430 is circulated through a condensing coil 102, which is continually wetted on the outside by a recirculating water system 106. Air is pulled over the condensing coil 102 by a fan 104, thus causing a small portion of the recirculating water to evaporate. The evaporation removes heat from the vapor in the condensing coil 102, causing the power cycle refrigerant 430 to condense. Therefore, the evaporative condenser 100 (or evaporative condenser 100a) functions as a heat transfer device between a process and its external environment.

The power cycle refrigerant 430 leaves the evaporative condenser 100 (or evaporative condenser 100a) as a saturated liquid and enters the mechanical pump 424. The mechanical pump 424 re-pressurizes the refrigerant 430 and circulates the power cycle refrigerant 430 back to the waste heat boiler 428. The pressurized power cycle refrigerant 430 then enters the boiler 428 to be vaporized once again to complete the power cycle 416.

In the vapor compression cooling cycle 418, the cooling cycle refrigerant 438 is pressurized by the compressor 434. The compressor discharge enters the evaporative condenser 100 (or evaporative condenser 100b) which liquefies the cooling cycle refrigerant 438, as similarly described above with respect to condensing the power cycle refrigerant 430 of the power cycle 416. The saturated cooling cycle refrigerant 438 is then passed into the expansion valve 450 where it is expanded to low pressure before entering the evaporator 440, where the cooling effect is generated.

It is understood that in certain embodiments, the evaporative condenser 100 may be separate unit evaporative condensers 100a, 100b instead of a single unit evaporative condenser 100 shared between the power cycle 416 and the cooling cycle 418.

The cooling cycle refrigerant 438 is throttled in the expansion valve 450 to decrease the refrigerant pressure and thus, the temperature. The expansion valve 450 can operate as a flow control device within the cooling cycle 418. The expansion valve 450 controls the amount of the cooling cycle refrigerant 438 flowing from the evaporative condenser 100 (or evaporative condenser 100b) to the evaporator 440. After the throttling process, the two-phase cooling cycle refrigerant 438 enters the evaporator 440 to absorb heat from a water stream to provide the desired cooling effect.

Referring to the embodiment shown in FIG. 10, the modular ORVC system 404 may be similar to the system of FIG. 9 but may further include a two-fluid recuperator 426 configured to receive heat exiting the mechanical pump. The two-fluid recuperator 426 improves the efficiency of the power cycle 416 by capturing some of the excess heat from the power cycle 416. In particular, the subcooled power cycle refrigerant 430 is heated by a discharge line from the turbine 432. After exiting the turbine 432, the power cycle refrigerant 430 is subcooled via the two-fluid recuperator 426 and the evaporative condenser 100 (or evaporative condenser 100a) but is preheated prior to reentering the waste heat boiler 428 to increase the efficiency of the modular ORVC system 404.

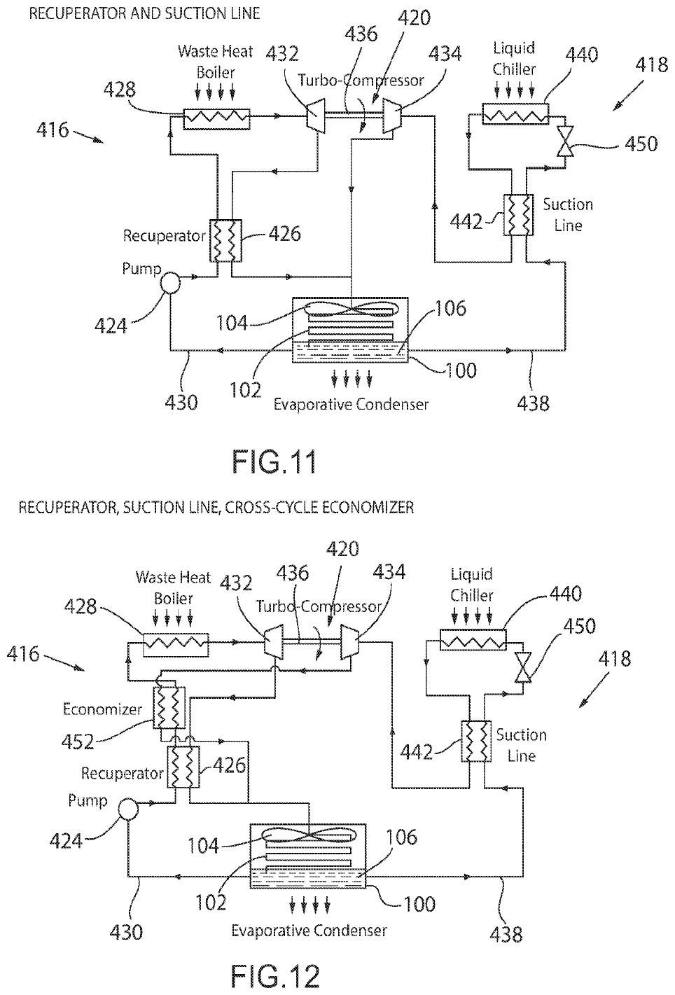

Referring to the embodiment shown in FIG. 11, the modular ORVC system 404 may be similar to the system of FIG. 10 but may further include a suction line heat exchanger (SLHX) 442. The SLHX 442 receives and precools the outgoing cooling cycle refrigerant 438 from the evaporative condenser 100 (or evaporative condenser 100b), which reduces the inlet enthalpy in the evaporator 440 and substantially improves the cooling duty of the cooling cycle 418.

The vapor cooling cycle refrigerant 438 exiting the evaporator 440 is then cooled and compressed to the condenser pressure by the compressor 434. Superheated vapor cooling cycle refrigerant 438 exiting the evaporator 440 passes through the second passageway and is heated by the SLHX 442. This also pre-cools the cooling cycle refrigerant 438 in the first passageway of the SLHX 442.

It is understood that any of the prior embodiments shown in FIGS. 9 through 10 can be combined with the SLHX 442 and may include any combination of additional elements described herein.

Referring to the embodiment shown in FIG. 12, the modular ORVC system 404 may be similar to the system of FIG. 11 but may further include an economizer 452. The economizer 452 is a heat exchanger that pre-heats the power cycle refrigerant 430 in the power cycle 416 prior to the power cycle refrigerant 430 entering the waste heat boiler 428. More particularly, the economizer 452 has a first passage for the cooling cycle refrigerant 438 that enters directly after discharge from the compressor 434, and a second passage for the power cycle refrigerant 430 to pass through. The cooling cycle refrigerant 438 is hotter than the power cycle refrigerant 430 at this stage of the cycles and thus heat is transferred to the power cycle refrigerant 430 to pre-heat the power cycle refrigerant 430 prior to entering the waste heat boiler 428. Thus, before entering the waste heat boiler 428, the power cycle refrigerant 430 is pre-heated a second time by the economizer 452.

It is understood that any of the prior embodiments shown in FIGS. 9 through 11 can be combined with the economizer 452 and may include any combination of additional elements described herein.

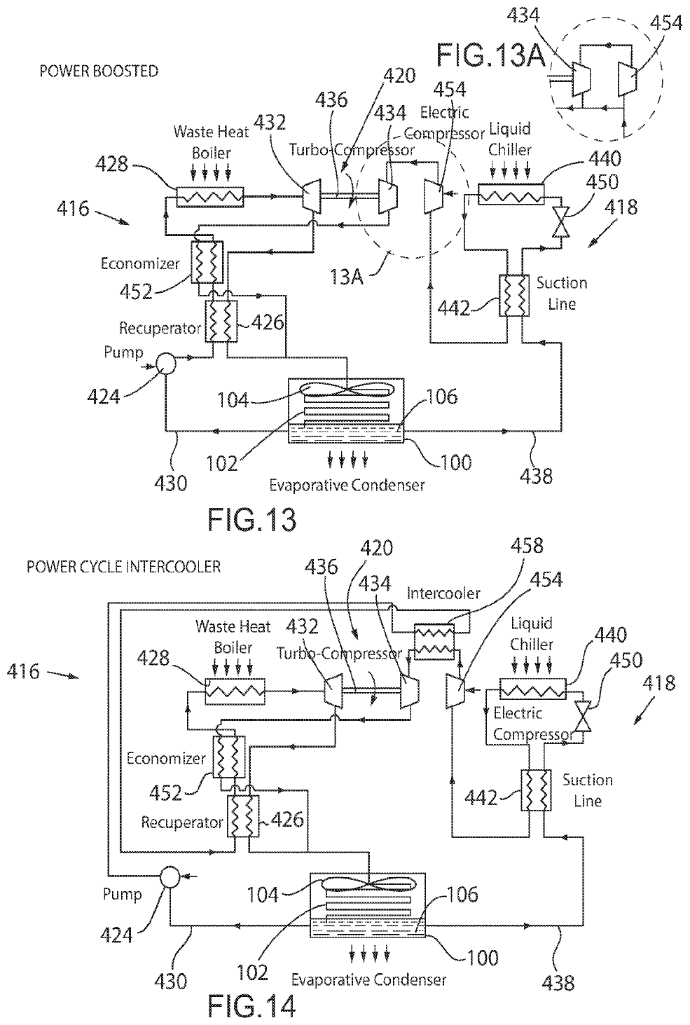

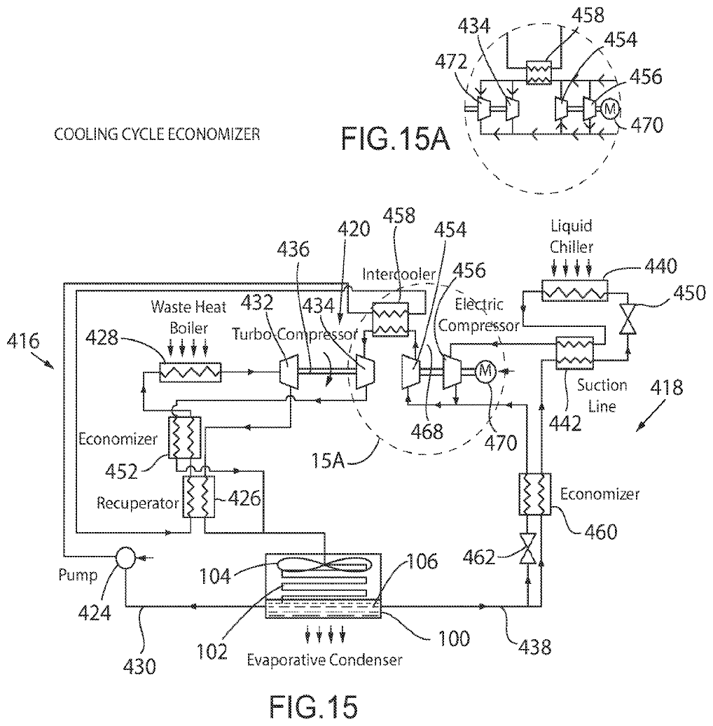

Referring to the embodiment shown in FIG. 13, the modular ORVC system 404 may be similar to the system of FIG. 12 except the modular ORVC system 404 may be power boosted by an electrically powered compressor 454. Thus, the modular ORVC system 404 may therefore include two compressors, the first is driven by mechanical work from the heat driven power cycle 416 and the electrically powered compressor 454 is driven by electricity of an electric generator or electric motor 470 (shown in FIG. 15). The overall system operates efficiently in this configuration such that the electrical requirements of the additional electrically powered compressor 454 are more than offset by the total system gains in efficiency.

In one embodiment, the turbine 432 and electrically powered compressor 434 are directly coupled to the single shaft 436. It is understood that the electrically powered compressor 454 may be included on or may be coupled to the single shaft 436, for example, when there is not sufficient waste heat to generate sufficient power for the compressor 434. It is understood that the electrically powered compressor 454 may be arranged in series with the single shaft 436 (as shown in FIG. 13), or parallel to the single shaft 436 (as shown in inset FIG. 13A).

It is understood that any of the prior embodiments shown in FIGS. 9 through 12 can be combined with the electrically powered compressor 454 to provide a power boosted modular ORVC system 404 and may include any combination of additional elements described herein.

Referring to the embodiment shown in FIG. 14, the modular ORVC system 404 may be similar to the system of FIG. 13 except further includes a power cycle intercooler 458 which receives the cooling cycle refrigerant 438 from the electrically powered compressor 454 and cools the outgoing cooling cycle refrigerant 438 exiting the electrically powered compressor 454 to reduce the inlet enthalpy in the compressor 434 and the power needed to compress the compressor 434. At the same time, power cycle refrigerant 430 receives the heat from the power cycle intercooler 458 and received by the two-fluid recuperator 426 where the power cycle refrigerant 430 is subcooled.

It is understood that the modular ORVC system 404 may optionally include the intercooler 458 (if power boosted by electrically powered compressor 454 as seen in FIG. 13) and may include any combination of additional elements described herein.

Referring to the embodiment shown in FIG. 15, the modular ORVC system 404 may be similar to the system of FIG. 14 except further includes a second electrically powered compressor 456 arranged on a second shaft 468 shared with the electrically powered compressor 454, with the electrically powered compressor 454 and second electrically powered compressor 456 driven by an electric motor 470 to provide multiple stages, e.g., two stages, of the electrically powered compressor. The electrically powered compressor 454 and the second electrically powered compressor 456 may be arranged in series with the compressor 434 (as shown in FIG. 15) or the electrically powered compressor 454 and the second electrically powered compressor 456 may be arranged parallel to the compressor 434 (as shown in inset FIG. 15A).

As shown in FIG. 15A, an additional compressor 472 of the turbo compressor 420 may be arranged on the same shaft 436 of the compressor 434 and arranged in series with the compressor 434 or may be arranged parallel to the compressor 434 (as shown in FIG. 15A) to provide multiple stages, e.g., two stages, of the turbo-compressor 420.

The modular ORVC system 404 may further include a cooling cycle economizer 460 which is a heat exchanger that receives the cooling cycle refrigerant 438 from the evaporative condenser 100 (or evaporative condenser 100b) and absorbs heat from the cooling cycle refrigerant 438 before entering the SLHX 442.

More particularly, the cooling cycle economizer 460 has a first passage for the cooling cycle refrigerant 438 that enters an expansion valve 462 to expand the cooling cycle refrigerant 438 to a lower pressure prior to being heated within the cooling cycle economizer 460 and returning to the electrically powered compressor 454.

A second passage of the cooling cycle economizer 460 allows the cooling cycle refrigerant 438 to directly enter the cooling cycle economizer 460 and pre-cools the cooling cycle refrigerant 438 before passing through to the SLHX 442.

The second electrically powered compressor 456 receives heated cooling cycle refrigerant 438 from the SLHX 442 and returns the heated cooling cycle refrigerant 438 to the electrically powered compressor 454 where the pressure is compressed to a same pressure of the cooling cycle refrigerant 438 leaving the first passage of the cooling cycle economizer 460 and thus boosting the inlet pressure and temperature of the cooling cycle refrigerant 438 flowing into the electrically powered compressor 454.

It is understood that the modular ORVC system 404 may optionally include the cooling cycle economizer 460 (if power boosted by the electrically powered compressor 454 and second electrically powered compressor 456 as seen in FIG. 13) and may be used with or without the use of the intercooler 458 and may include any combination of additional elements described herein.

### Data and Results

The data and results shown in Table 8 and 9 refer specifically to the modular ORVC system 404 with the configuration shown in FIG. 12. The evaporative condenser 100 of the modular ORVC system 404 has two different sizes (101 ft² and 217 ft²). The results are compared to a turbo-compression cooling system (“TCCS”) cooling system that uses a cooling tower (101 ft²) and a broad absorption system (“Board X Absorption”) that uses a cooling tower (101 ft²)

As seen in Table 8, in a comparison of the modular ORVC system 404 using an evaporative condenser (102 ft²) and a cooling system that uses a cooling tower (101 ft²) of approximately the same size, there is improved performance in the modular ORVC system 404. For example, the saturation temperature is lowered from 100° F. to 98° F. The modular ORVC system 404 provides an improved thermal COP (0.81 vs 0.76) and plant electrical COP (13.9 vs 12.9) over the cooling tower absorption system. The modular ORVC system 404 also provides for the removal of the large water circulation pump found in the cooling tower absorption systems.

TABLE 8

| System: | TCCS | TCCS |
|---|---|---|
| Heat Rejection Mode | 101 ft² Cooling | 102 ft² Evaporative |
| | Tower | Condenser |
| Hot Water Inlet/ | 97.8 C./87.8 C. | |
| Outlet Temperature | 208 F./190 F. | |
| Chilled Water Inlet/ | 13.7 C./6.7 C. | |
| Outlet Temperature | 56.7 F./44 F. | |
| Cooling Duty | 512 kW (146-tons) | |
| Heat Input [kW] | 670 | 635 |
| Thermal COP | 0.76 | 0.81 |
| Refrigerant Pump | 12.8 | 12.2 |
| Electricity [kW] | | |
| Cooling Tower Fan Motor | 14.9 | 22.4 |
| Electricity [kW] | | |
| Circulating Water Pump | 22.4 | 2.24 |
| Electricity [kW] | | |
| Total Electricity [kW] | 50.0 | 36.8 |
| Total COP | 0.711 | 0.762 |

As seen in Table 9, by increasing the evaporative condenser size (217 ft²), it allows for the saturation temperature to approach wet bulb temperature (78° F. wet bulb-88° F. sat. temp), which are temperatures that are not achievable with a separate cooling loop of the cooling tower system. The total plant COP>1 of the modular ORVC system 404 is an improvement over the COP (0.762) of the evaporative condenser system with a smaller evaporative condenser (102 ft²).

TABLE 9

| System: | TCCS | TCCS |
|---|---|---|
| Heat Rejection Mode | 102 ft² Evaporative | 217 ft² Evaporative |
| | Condenser | Condenser |
| Hot Water Inlet/ | 97.8 C./87.8 C. | |
| Outlet Temperature | 208 F./190 F. | |
| Chilled Water Inlet/ | 13.7 C./6.7 C. | |
| Outlet Temperature | 56.7 F./44 F. | |
| Cooling Duty | 512 kW (146-tons) | |
| Heat Input [kW] | 635 | 473 |
| Thermal COP | 0.81 | 1.08 |
| Refrigerant Pump | 12.2 | 9.21 |
| Electricity [kW] | | |
| Cooling Tower Fan Motor | 22.4 | 18.6 |
| Electricity [kW] | | |
| Circulating Water Pump | 2.24 | 5.59 |
| Electricity [kW] | | |
| Total Electricity [kW] | 36.8 | 33.4 |
| Total COP | 0.762 | 1.012 |

It is understood that the piping, fittings, valves, and heat exchangers may be constructed with low-cost steel or aluminum materials. Therefore, the piping, fittings, valves, and heat exchangers may be constructed of the same material. The evaporative condenser may be manufactured with a different material and may be carbon steel.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions and nomenclature that apply throughout this disclosure will now be presented.

Nomenclature

| | |
|---|---|
| COP | Coefficient of performance |
| GWP | Global warming potential |
| HFC | Hydrofluorocarbon |
| HFO | Hydrofluoroolefin |
| HVAC | Heating, ventilation, air conditioning |
| ODP | Ozone depleting potential |
| ORC | Organic Rankine cycle |
| PID | Proportional-Integral-Derivative |
| SC | Subcooled region |
| SH | Superheated region |
| SLHX | Suction line heat exchanger |
| TP | Two-phase region |
| VC | Vapor compression cycle |
| VFD | Variable frequency drive |
| ORVC | Organic Rankine-vapor compression cycle |
| COP | Coefficient of performance [—] |
| Cr | Heat capacity rate [kW K⁻¹] |
| Cp | Specific heat capacity [kJ kg⁻¹ K⁻¹] |
| h | Enthalpy [kJ kg⁻¹] |
| \dot{m} | Mass flowrate [kg s⁻¹] |
| ΔP | Pressure loss [kPa] |
| Q\dot{ } | Rate of heat transfer [kW] |
| UA | Heat transfer conductance [kW K⁻¹] |
| \dot{W} | Rate of work transfer [kW] |
| ε | Heat exchanger effectiveness [—] |
| η | Efficiency [—] |
| avg | Average |
| comp | Compressor |
| elec | Electrical |
| evap | Cooling cycle evaporator |
| in | Inlet |
| out | Outlet |
| r | Refrigerant |
| min | Minimum |
| s | Isentropic property |
| shaft | Turbo-compressor shaft |
| th | Thermal |
| turb | Turbine |

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” means, “including, but not necessarily limited to”; it specifically indicates open-ended inclusion or membership in a so-described combination, group, series and the like.

A “thermal fluid” is defined as any working fluid optimized for use in a power/heating cycle. A “cooling fluid” is defined as any working fluid optimized for use in a cooling/refrigeration cycle. In some instances, a thermal fluid and cooling fluid can be the same, such as water, which can operate both a power cycle and cooling cycle.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

References to “a controller” and “a processor” or “the microcontroller” and “the processor,” can be understood to include one or more microprocessors that can communicate in a stand-alone and/or a distributed environment(s), and can thus be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

What we claim is:

1. A system for turbo-compression cooling in a facility having a cooling loop and a generator having a plurality of waste heat streams, the system comprising:
a power cycle comprising:
a first working fluid;
a waste heat boiler configured to evaporate the working fluid, the waste heat boiler configured to receive waste heat from one or more of the plurality of waste heat streams from the generator;
a turbine configured to receive the evaporated first working fluid from the waste heat boiler, the turbine having a plurality of vanes disposed around a central shaft and configured to rotate about the central shaft, the plurality of vanes configured to rotate as the first working fluid expands to a lower pressure; and
a first evaporative condenser configured to receive the first working fluid from the turbine and configured to condense the first working fluid to a saturated or subcooled liquid;
a cooling cycle comprising:
a second working fluid;
a first compressor configured to increase the pressure of the second working fluid;
a second evaporative condenser configured to receive the second working fluid from the first compressor and configured to condense the second working fluid to a saturated or subcooled liquid;
an expansion valve configured to receive the second working fluid from said evaporative condenser and configured to expand the second working fluid to a lower pressure;
an evaporator configured to receive the second working fluid from the expansion valve and configured to reject heat from a circulating fluid to the second working fluid, thereby cooling the circulating fluid; and
wherein the turbine and first compressor are coupled to the other, thereby coupling the power cycle and the cooling cycle.

2. The system of claim 1 wherein the first evaporative condenser and second evaporative condenser are a common unit.

3. The system of claim 1 wherein the first evaporative condenser and second evaporative condenser comprise a coil receiving the first and second working fluid, respectively, and a recirculating water system configured to deposit spray water on an exterior of the coil.

4. The system of claim 3 wherein the first evaporative condenser and second evaporative condenser further comprise a fan configured to pull air over the coil.

5. The system of claim 1 wherein the first and second working fluid is a single refrigerant.

6. The system of claim 5 wherein the single refrigerant is R1234ze(E).

7. The system of claim 1 further comprising a recuperator configured to receive heat rejected by the first working fluid, and wherein the recuperator is configured to transfer the rejected heat to the saturated or subcooled liquid as the first working fluid re-enters the waste heat boiler.

8. The system of claim 7 further comprising a cross-cycle economizer configured to receive and cool the second working fluid exiting the first compressor and heat the first fluid exiting the pump.

9. The system of claim 1 further comprising a suction-line heat exchanger configured to receive and heat the second working fluid prior to compressing the second working fluid via the first compressor.

10. The system of claim 1 further comprising a second compressor configured to discharge the second working fluid to the first compressor
wherein the second compressor is electrically powered; and
wherein the first compressor is powered via the waste heat from the waste heat boiler.

11. The system of claim 10 further comprising a third compressor configured to discharge the second working fluid from the third compressor to the second compressor
wherein the third compressor is electrically powered.

12. The system of claim 10 further comprising a cooling-cycle economizer configured to receive and cool a first portion of the second working fluid prior to entering the evaporator and to receive a second portion of the second working fluid expanded by a second expansion valve and exiting the second evaporative condenser prior to entering the cooling-cycle economizer.

13. The system of claim 10 further comprising an intercooler configured to receive and cool the second working fluid from the second compressor prior to compressing the second working fluid via the first compressor.

14. The system of claim 11 further comprising a fourth compressor configured to discharge the second working fluid to the first compressor
wherein the fourth compressor is powered via the waste heat from the waste heat boiler.

15. The system of claim 1 wherein the circulating fluid is at least one of water, water glycol mixture, ammonia, and air and is part of the cooling loop.

16. A method of turbo-compression cooling, the method comprising:
receiving, from a waste heat source, heat waste in a waste heat boiler;
evaporating a first working fluid using the heat waste in the waste heat boiler;
generating mechanical power through expansion of the first working fluid to a lower pressure in a turbine, the expansion of the first working fluid rotating one or more turbine vanes;
condensing the first working fluid to a saturated or subcooled liquid in a first evaporative condenser;
pressurizing the saturated or subcooled liquid through a mechanical pump to re-enter the waste heat boiler;
transferring the generated mechanical power to a first compressor, the first compressor configured to receive a second working fluid;
compressing the second working fluid via the first compressor thereby increasing the pressure of the saturated vapor;
condensing the second working fluid in a second evaporative condenser to a saturated or subcooled liquid;
expanding the second working fluid to a lower pressure via an expansion valve; and
rejecting heat through an evaporator from circulating cooling fluid to the second working fluid.

17. The method of claim 16 wherein the first and second evaporative condenser are a single unit.

18. The method of claim 16 further comprising receiving the first and second working fluid in a coil of the first and second evaporative condenser, respectively, and disposing spray water on an exterior of the coil.

19. The method of claim 18 further comprising pulling air over the exterior of the coil.

20. The method of claim 16 further comprising rejecting heat from the first working fluid exiting the turbine in a recuperator, and absorbing heat into the first working fluid exiting the mechanical pump in the recuperator.

21. The method of claim 16 further comprising rejecting heat from the second working fluid after discharge from a cross cycle economizer, and absorbing heat into the first working fluid exiting the mechanical pump in the economizer.

22. The method of claim 16 further comprising receiving and heating the second working fluid prior to compressing the second working fluid via the first compressor.

23. The method of claim 16 further comprising
compressing the second working fluid via a second compressor powered separately from the first compressor; and
discharging the second working fluid from the second compressor to the first compressor.

24. The method of claim 23 further comprising
compressing the second working fluid via a third compressor, and
discharging the second working fluid from the third compressor to the second compressor.

25. The method of claim 23 further comprising receiving and cooling a first portion of the second working fluid prior to entering the evaporator via a cooling cycle economizer and expanding a second portion of the second working fluid prior to entering the cooling cycle economizer via a second expansion valve.
